(19) United States
(12) Patent Application Publication
(10) Pub. No.: US 2026/0036990 A1
(43) Pub. Date: Feb. 5, 2026

(54) VEHICLE TRAJECTORY PRIORITIZATION IN AUTONOMOUS VEHICLE SYSTEM

(71) Applicant: Glydways Inc., South San Francisco, CA (US)

(72) Inventor: Mark E. Seeger, South San Francisco, CA (US)

(21) Appl. No.: 19/288,823

(22) Filed: Aug. 1, 2025

Related U.S. Application Data
(60) Provisional application No. 63/678,989, filed on Aug. 2, 2024.

(51) Int. Cl. G05D 1/633; G05D 1/69; G05D 103/00; G05D 105/22; G05D 107/13; G05D 109/10

(52) U.S. Cl. CPC G05D 1/633; G05D 1/69; G05D 2103/00; G05D 2105/22; G05D 2107/13; G05D 2109/10

(57) ABSTRACT

Methods, apparatuses, and systems for navigating vehicles along a roadway are described. A transportation system can control a set of autonomous vehicles navigating along a section of a roadway by providing a set of moving position-targets. The set of autonomous vehicles includes a first vehicle following a first moving position-target. The system determines a priority path for a second vehicle having a right-of-way priority along the section of the roadway, and associated with an exclusion area. The system then determines, based on location information for the first vehicle, that the first vehicle interferes with the exclusion area. A revised moving position-target is configured to remove the first vehicle from the exclusion area. The system then transmits, to the first vehicle, route information corresponding to the revised moving position-target, causing the first vehicle to avoid the exclusion area.

### CROSS-REFERENCE TO RELATED APPLICATION

This application is a nonprovisional patent application of and claims the benefit under 35 U.S.C. § 119(e) of U.S. Provisional Patent Application No. 63/678,989, filed Aug. 2, 2024, and titled “Vehicle Trajectory Prioritization in Autonomous Vehicle System,” the contents of which are incorporated herein by reference in its entirety.

### FIELD

The described embodiments relate generally to transportation systems, and, more particularly, to transportation systems using vehicle trajectory control schemes for autonomous vehicle operation.

### BACKGROUND

Vehicles, such as cars, trucks, vans, buses, trams, and the like, are ubiquitous in modern society. Cars, trucks, and vans are frequently used for personal transportation to transport relatively small numbers of passengers, while buses, trams, and other large vehicles are frequently used for public transportation. Vehicles may also be used for package transport or other purposes. Such vehicles may be driven on roads, which may include surface roads, bridges, highways, overpasses, or other types of vehicle rights-of-way. Driverless or autonomous vehicles may relieve individuals of the need to manually operate the vehicles for their transportation needs.

### SUMMARY

A method of navigating vehicles along a roadway, may include controlling a set of autonomous vehicles navigating along a section of the roadway by providing a set of moving position-targets for the set of autonomous vehicles, wherein the set of autonomous vehicles includes a first vehicle following a first moving position-target of the set of moving position-targets. The method may further include determining that the first moving position-target interferes with a priority path for a second vehicle, determining a revised moving position-target for the first vehicle, the revised moving position-target configured to cause the first vehicle to avoid the priority path, and transmitting, to the first vehicle, route information corresponding to the revised moving position-target, thereby causing the first vehicle to follow the revised moving position-target and avoid the priority path. Transmitting the route information corresponding to the revised moving position-target may include transmitting route information that causes the first vehicle to perform at least one of exiting the roadway or proceeding to a stationary position target. Determining that the first moving position-target interferes with the priority path for the second vehicle may include determining that the first moving position-target overlaps an exclusion area associated with the second vehicle.

The method may further include detecting that the second vehicle has passed the first vehicle, and in response to detecting that the second vehicle has passed the first vehicle, transmitting, to the first vehicle, route information corresponding to the first moving position-target, thereby causing the first vehicle to return to the first moving position-target of the set of moving position-targets.

The set of moving position-targets may include a first set of moving position-targets and a second set of moving position-targets, the first moving position-target may be one of the first set of moving position-targets, and the revised moving position-target may be one of the second set of moving position-targets. The set of moving position-targets may be a first set of moving position-targets, and the priority path may be associated with a second moving position-target of a second set of moving position-targets associated with a right-of-way priority, wherein each of at least a subset of moving position-targets of the second set of moving position-targets traverses the section of the roadway at a greater speed than moving position-targets of the first set of moving position-targets.

The second vehicle may be associated with a second priority level greater than a first priority level for the set of autonomous vehicles. The second priority level of the second vehicle may be associated with emergency response vehicles. The second priority level of the second vehicle may be associated with a mass-transit vehicle. The second vehicle may be a human operated vehicle.

A method of navigating vehicles along a roadway, may include controlling a set of autonomous vehicles navigating along a section of the roadway by providing a set of moving position-targets for the set of autonomous vehicles, wherein the set of autonomous vehicles includes a first vehicle following a first moving position-target of the set of moving position-targets. The method may further include determining, based at least in part on location information for the first vehicle, that the first vehicle interferes with an exclusion area associated with a second vehicle having right-of-way priority along a priority path of the section of the roadway, in response to determining that the first vehicle interferes with the exclusion area, determining a revised moving position-target for the first vehicle, the revised moving position-target configured to remove the first vehicle from the exclusion area, transmitting, to the first vehicle, first route information corresponding to the revised moving position-target, thereby causing the first vehicle to follow the revised moving position-target and avoid the exclusion area, detecting that the exclusion area of the second vehicle may have passed the first vehicle, and transmitting, to the first vehicle, second route information corresponding to one of the set of moving position-targets, thereby causing the first vehicle to return to the first moving position-target or a second moving position-target of the set of moving position-targets.

The set of moving position-targets may include a first set of moving position-targets and a second set of moving position-targets, the first moving position-target may be one of the first set of moving position-targets, and the revised moving position-target may be one of the second set of moving position-targets.

The set of moving position-targets may be a first set of moving position-targets, and the priority path may be associated with a moving position-target of a second set of moving position-targets, the second set of moving position-targets associated with the right-of-way priority, wherein each of at least a subset of moving position-targets of the second set of moving position-targets traverses the section of the roadway at a greater speed than moving position-targets of the first set of moving position-targets.

Transmitting the first route information corresponding to the revised moving position-target may include transmitting route information that causes the first vehicle to perform at least one of exiting the roadway or proceeding to a stationary position target.

A transportation system may include a set of autonomous vehicles that includes a first vehicle and a vehicle controller. The vehicle controller may be configured to control the set of autonomous vehicles navigating along a section of a roadway by providing a set of moving position-targets for the set of autonomous vehicles, wherein the first vehicle follows a first moving position-target of the set of moving position-targets, determine a priority path along the section of the roadway for a second vehicle having a right-of-way priority along the section of the roadway, the second vehicle associated with an exclusion area extending ahead of the second vehicle along the priority path, determine, based at least in part on location information for the first vehicle, that the first vehicle interferes with the exclusion area associated with the second vehicle, determine a revised moving position-target for the first vehicle, the revised moving position-target configured to remove the first vehicle from the exclusion area, and transmit, to the first vehicle, route information corresponding to the revised moving position-target, thereby causing the first vehicle to follow the revised moving position-target and avoid the exclusion area. The exclusion area may extend a first distance ahead of the second vehicle in the direction of travel and a second distance behind the second vehicle.

The vehicle controller may be further configured to detect that the exclusion area of the second vehicle has passed the first vehicle, and in response to detecting that the exclusion area of the second vehicle has passed the first vehicle transmit, to the first vehicle, route information corresponding to the first moving position-target, thereby causing the first vehicle to return to the first moving position-target of the set of moving position-targets.

The set of moving position-targets may include a first set of moving position-targets and a second set of moving position-targets, the first moving position-target may be one of the first set of moving position-targets, and the revised moving position-target may be one of the second set of moving position-targets.

The set of moving position-targets may be a first set of moving position-targets, and the priority path may be associated with a second moving position-target of a second set of moving position-targets, the second set of moving position-targets associated with the right-of-way priority, wherein each of at least a subset of moving position-targets of the second set of moving position-targets traverses the section of the roadway at a greater speed than moving position-targets of the first set of moving position-targets.

Transmitting the route information corresponding to the revised moving position-target may include transmitting route information that causes the first vehicle to perform at least one of exiting the roadway or proceeding to a stationary position target.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts a portion of an example roadway of a transportation system.

FIG. 1B depicts a schematic representation of an example transportation system.

FIGS. 2A-2D depicts an example section of roadway of a transportation system.

FIGS. 3A-3B depict a portion of an example trunk lane of a roadway system.

FIGS. 4A-4C depict another example section of roadway of a transportation system.

FIGS. 5A-5C depict another example section of roadway of a transportation system.

FIGS. 6A-6C depict another example section of roadway of a transportation system.

FIGS. 7A-7C depict another example section of roadway of a transportation system.

FIGS. 8A-8C depict another example section of roadway of a transportation system.

FIGS. 9A-9C depict another example section of roadway of a transportation system.

FIG. 10 depicts another example section of a roadway system.

FIG. 11 depicts an example method of navigating vehicles along a roadway.

FIG. 12 depicts another example method of navigating vehicles along a roadway.

FIGS. 13A-13B depict an example vehicle.

FIG. 14 depicts a block diagram of an example vehicle.

FIGS. 15A-15B depict the vehicle of FIGS. 13A-13B with its doors open.

FIG. 16 illustrates an electrical block diagram of an electronic device that may perform the operations described herein.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The embodiments herein are generally directed to a transportation system in which numerous vehicles may be autonomously operated to transport passengers and/or freight along roadways within a roadway system or network. For example, a transportation system or service may provide a fleet of vehicles that operate in a roadway system to pick up and drop off passengers at pre-set locations or stops (e.g., boarding zones). In some cases, the vehicles may also pick up and drop off passengers at dynamically selected locations outside of boarding zones. Additionally, the transportation or service using autonomously-operated vehicles may be integrated with roadways that include non-autonomous vehicles. As used herein, the term “roadway” may refer to a structure that supports moving vehicles, which may include autonomous vehicles, or both autonomous and non-autonomous vehicles.

Existing roadways typically include multiple predefined lanes that are not designated to a particular vehicle type or use. For example, residential streets may have no lane indications or designations at all. A two-lane rural road or highway may have a single travel lane in either direction, including a center line indication. A four-lane divided highway may have two travel lanes in either direction that include lane indications or markers, and separated by a median of some width. Such larger highway-type systems may include controlled entry and exit paths (on-ramps and off-ramps).

However, existing or future roadways may include one or more lanes that are dedicated for a particular use. The particular use may include autonomous vehicles. In other cases, the particular use may include mass-transit vehicles (e.g., busses, trams, etc.) or carpools. The particular use may include a combination of these, including mass-transit and autonomous vehicles. For example, a bus lane may be designated for use only by buses. Or, a high-occupancy lane may be designated for use by buses and automobiles carrying at least a minimum number of occupants (e.g., 3 or more persons in a car). In one example, a divided highway or other controlled-access roadway may include a dedicated lane in addition to one or more regular travel lanes in one direction, where the dedicated lane may be accessible by changing lanes from one of the regular lanes. “Regular lanes” may include lanes (e.g., legacy lanes) that are open to use by non-autonomous vehicles, including human-driven or human-operated vehicles. “Regular lanes” may also include any lane that is not otherwise dedicated or designated for a particular use. The roadway in the opposite direction may similarly have a dedicated lane and one or more regular lanes supporting traffic in the opposite direction. In another example, a divided highway or other controlled-access roadway may include three sets of lanes: one or more regular lanes in a first direction, one or more regular lanes in a second direction, and a pair of dedicated lanes where one runs in the first direction and the other in the second direction. As such, the dedicated lanes may be physically separated from the regular lanes, and may have separate entry and exit paths.

Additionally, some existing or future roadways may have a physical width, but lack physical lane indications. It may be desirable to allow the flexible use of the roadway for different configurations and uses, for example at different times of the day, days of the week, or during different seasons.

Autonomous operation of a vehicle is a complicated task, however, and the particular techniques or schemes employed by the transportation system to control the vehicles on the roadway may have a dramatic effect on the operation of the overall system. For example, some vehicle control schemes may be susceptible to causing or propagating traffic jams or other disturbances that negatively affect the operation and/or efficiency of the system. Furthermore, the transportation system should be designed to reduce or minimize the possibility of collisions or other adverse encounters between vehicles. However, in some cases, control schemes that are optimized or tuned to avoid traffic disturbances, collisions, or other adverse encounters may be inflexible, space inefficient, or may otherwise reduce the quality of the user experience. Accordingly, described herein are techniques, systems, and methods for controlling autonomous vehicles in a transportation system in order to provide high levels of safety and efficiency, all while maintaining a superior user experience.

Additionally, in some cases, it may be desirable to allow non-autonomous vehicles to be integrated into roadways that include autonomous vehicles. The overall system may thus be complicated. For example, a roadway used by autonomous vehicles may need to account for emergency, or other vehicles having a higher priority than other vehicles. Examples of higher priority vehicles can include police, fire, ambulance, or other emergency response vehicles. Further examples of higher priority vehicles may be those designated by the owner or operator of the roadway as having a higher priority than other, lower priority vehicles. For example, higher-occupancy vehicles may be considered higher priority, such as buses, carpools, vans, and so on. In another example, autonomous vehicles themselves may have different tiers or service levels, such that a first category of autonomous vehicles (e.g., a first group of autonomous vehicles described herein) may be considered higher priority, and a second category of autonomous vehicles may be considered lower priority (e.g., a second group of autonomous vehicles described herein). Such priority levels may be static (e.g., for emergency vehicles, buses, or a passholder), or dynamic (e.g., where a toll is paid to temporarily change priority levels of an autonomous or non-autonomous vehicle).

One example vehicle control scheme described herein establishes virtual position targets (referred to herein as moving position-targets or simply as position targets) that move along a roadway and act as targets (or position setpoints) for the autonomous vehicles. When a vehicle is traveling along a roadway segment that utilizes this type of control scheme, the vehicle may be assigned to or otherwise associated with a particular moving position-target, and the vehicle may adjust its speed and/or heading to minimize the error between its actual position and the position of the moving position-target. Each autonomous vehicle that is on that roadway segment may be assigned to or otherwise associated with a different moving position-target, and the moving position-targets may be predetermined (e.g., by a function that relates position along the roadway with time) so that the vehicles maintain a safe distance (headway) from one another. In this way, the locations of individual vehicles on the roadway and the overall flow of vehicles along the roadway segment may be tightly controlled, thereby reducing the risk of traffic jams, collisions, or the like. As used herein, a vehicle control scheme in which vehicles navigate by following moving position-targets may be referred to as a moving position-target vehicle control scheme.

The roadways of the transportation system described herein may be large and complex, however, and may benefit from employing different vehicle control schemes along different segments of the system. For example, a first vehicle control scheme in which the vehicles are configured to autonomously form platoons or groups of multiple vehicles may be employed along some segments of the roadway, and a second vehicle control scheme, such as a moving position-target vehicle control scheme, may be employed along other segments of the roadway.

In examples of vehicle control schemes described herein, the system may provide allowance for higher priority vehicles (which may be autonomous or non-autonomous) to operate on a roadway together with lower priority autonomous vehicles. The system may designate or otherwise recognize an exclusion area ahead of (and/or around) the higher priority vehicle. This higher priority vehicle may be another autonomous vehicle in some cases, or may be a non-autonomous vehicle in other cases. Such systems may operate on roadways that are configurable and reconfigurable, for example via software control. That is, even where multiple lanes are present, such lanes may be software-defined (e.g., via system control) and not necessarily physically defined (e.g., via painted, lighted, or structural lane markings or indicators). Examples of such vehicle control schemes and roadways, as well as techniques for accommodating different priority vehicles therein, are described herein.

In some embodiments, a set of autonomous vehicles may be navigating along a section of roadway following moving position-targets under the control of a transportation system, as further described herein. Another vehicle that has a right-of-way priority (e.g., higher priority than the relatively lower-priority vehicles of the set of autonomous vehicles), may travel along a priority path on the section of roadway. The transportation system may determine that one or more vehicles of the set of autonomous vehicles interferes with an exclusion area for the vehicle having the right-of-way priority. As a result, the transportation system may provide the interfering vehicles with revised moving position-targets to remove those vehicles from the exclusion area. After the vehicle having the right-of-way priority has passed the interfering vehicles, such that those vehicles would no longer interfere with the exclusion area, those vehicles may be returned to moving position-targets. The moving position-targets may be the same (original) moving position-targets, or different moving position-targets.

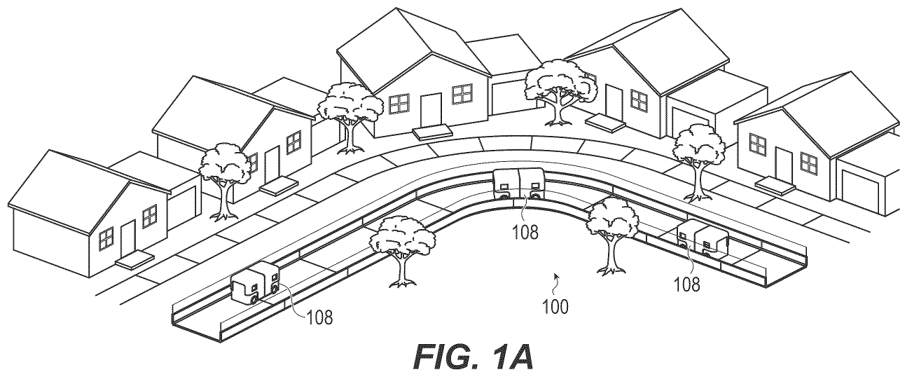

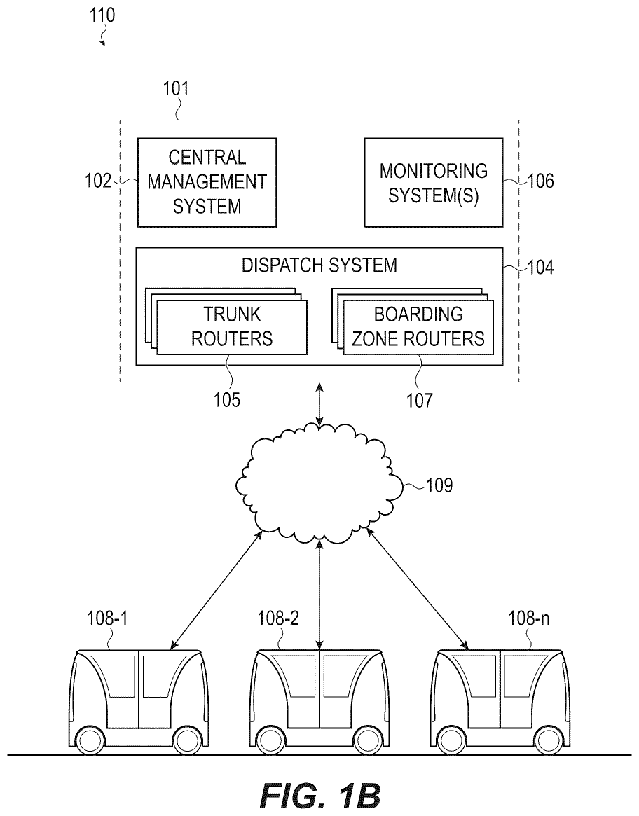

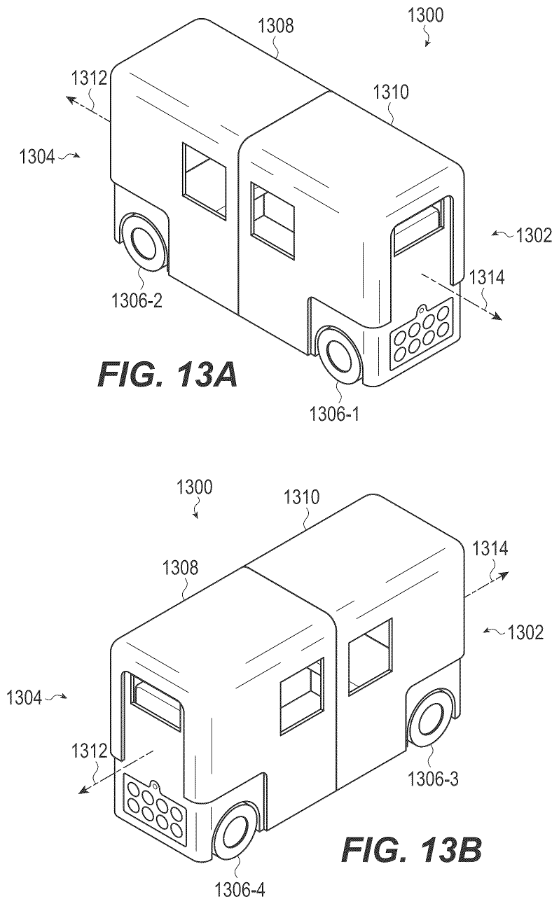

FIG. 1A illustrates a segment of a roadway system 100 for autonomous vehicles 108, in accordance with embodiments described herein. The roadway system 100 that is shown in FIG. 1A is shown at ground level, in a typical urban or suburban environment, though this is not meant to be limiting. Indeed, the roadway system (or simply roadway) may be deployed in any environment or location, including rural locations, entirely or partially inside buildings, away from roadways, on elevated structures, underground, or the like. The roadway system 100 is shown with a plurality of four-wheeled autonomous vehicles 108 navigating along the roadway system 100. The autonomous vehicles 108 may be autonomous or semi-autonomous vehicles specifically designed for use with the roadway system 100. One example type of vehicle for use with the roadway system 100 is described with respect to FIGS. 13A-15B, though other types of vehicles may be driven along the roadway system 100 instead of or in addition to those described herein. The roadway system 100, of which the segment shown in FIG. 1A may only be a small portion, may include multiple segments including straightaways, turns, bridges, tunnels, ramps, and the like. As used herein, a roadway system may describe the set of physical structures of a transportation system where vehicles may operate, and may include trunk lanes, boarding zones, parking facilities (e.g., parking lots, parking garages), maintenance facilities, intersections, merging zones, and the like.

FIG. 1B depicts an example transportation system 110 that may use and/or implement the techniques and include the systems and infrastructure described herein. The transportation system 110 includes a control system 101 that can communicate with autonomous vehicles 108 (e.g., vehicles 108-1, . . . , 108-n) of the transportation system 110 (as well as numerous other systems, components, sensors, etc.), to facilitate the operations of the transportation system 110. The control system 101 may include a central management system 102, a dispatch system 104, and one or more track monitoring system(s) 106 (though the control system 101 may include or be implemented by different systems or combinations of systems). The various systems, components, computers, servers, sensors, etc., of the transportation system 110 may communicate via one or more communication systems and/or networks 109. While the control system 101 is shown as having certain discrete subsystems, these subsystems may be combined in some example transportation systems. More particularly, functions and/or operations that are described herein as being performed or otherwise associated with the central management system 102, the dispatch system 104, and the monitoring system 106 may be performed by a single integrated system, or may be split into further subsystems. Moreover, additional systems, subsystems, modules, controllers, and the like may be included in the control system 101. More generally, a particular association between a function or operation and a portion or subsystem of the control system 101 relates to an example implementation, and in other example implementations, different functions and/or operations are associated with and/or performed by other portions or subsystems.

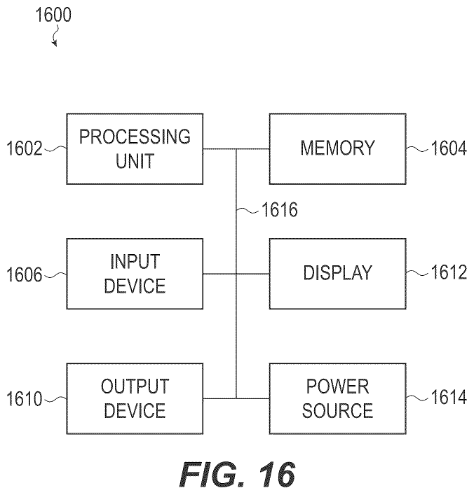

The control system 101 may include and/or be instantiated by one or more electronic devices (e.g., computer systems), such as the electronic device 1600 described with respect to FIG. 16.

The central management system (CMS) 102 may be configured to automatically allocate resources across the network. This may include allocating vehicles to service trip requests from users, pre-positioning vehicles at boarding zones in anticipation of projected ridership, allocating vehicles to and/or from maintenance and storage facilities in response to vehicle state and current and/or projected system demands, and the like.

The CMS 102 may maintain a real-time model of full-system status, including the location of every autonomous vehicle in the system, as well as the assigned trajectories for each vehicle (e.g., the spacetime trajectory that the vehicle is assigned to traverse and/or is currently traversing). As noted herein, the trajectory for a vehicle may define the position, velocity, and acceleration of a vehicle (and optionally jerk and/or other vehicle parameters) within the transportation system as a function of time, and thus both provides the CMS 102 information about where each vehicle will be at a given time (e.g., in the future), and also provides individual vehicles with instructions for how to traverse a path within the system. More specifically, the trajectory for a vehicle may define the location and velocity of the vehicle at all times as it executes a trip, and the vehicle may autonomously maintain coincidence with its expected position, velocity, acceleration, etc. (to an allowable degree of deviation or error). Stated another way, the vehicle is configured to follow (e.g., maintain coincidence with) its position, velocity, and acceleration target as defined by the vehicle trajectory, such that the vehicle is always at its expected position and speed at the expected time. It will be understood that a spacetime trajectory may specify more or fewer (or different) sets of parameters for a vehicle. For example, a spacetime trajectory may define the position of a vehicle with respect to time, and the particular velocity and acceleration of the vehicle may not be predetermined by the spacetime trajectory. As another example, a spacetime trajectory may define a position and a velocity of the vehicle with respect to time. Many of the techniques described herein may be used with various implementations of spacetime trajectories, such as spacetime trajectories that define only position with respect to time.

The CMS 102 may also facilitate both automated and human supervision of the entire transportation system 110. For example, the CMS 102 may receive information from other systems or components of the transportation system 110 (e.g., vehicles, sensors, the track monitoring system 106, the dispatch system 104, etc.), and make adjustments to the system as necessary.

In some cases, the CMS 102 receives trip requests (and optionally other information) from users of the system. Trip requests may include information such as the identity of the requestor, an origin location (e.g., a boarding zone or other location where the user is to be picked up), a destination location (e.g., a boarding zone or other location where the user is to be dropped off), and, optionally, a requested trip start time (e.g., a time at which the vehicle should arrive at the origin location) or trip end time (e.g., a time at which the vehicle should arrive at the destination location). Trip requests may be sent to the CMS 102 via smartphones, kiosks (e.g., at boarding zones or other locations), computers, conventional telephones, wearable devices, or any other suitable device and/or communication technique. The CMS 102 may include and/or be instantiated by one or more electronic devices, (e.g., computer systems), such as the electronic device 1600 described with respect to FIG. 16.

In some cases, the control system 101 may determine paths for trip requests. For example, based on a trip request that specifies an origin location (e.g., origin boarding zone) and destination location (e.g., destination boarding zone), the control system 101 may determine a path, through the transportation system, that extends from the origin boarding zone, along at least a portion of a trunk lane of the roadway system, to the destination boarding zone. In some cases, paths are generated by the CMS 102 (e.g., a vehicle routing or path generating subsystem of the CMS 102), the dispatch system 104, or another subsystem or module of the control system 101.

The control system 101 may include a dispatch system 104. The dispatch system 104 may determine the trajectories for vehicles and may generally control how the vehicles travel throughout the transportation system. The dispatch system 104 may include trunk router(s) 105 and boarding zone router(s) 107.

Trunk routers may manage vehicle allocations along associated trunk lanes. For example, a trunk router may define or otherwise manage moving position-targets along its associated trunk lane(s), and may manage vehicle reservations on the moving position-targets. For example, in response to a request from a boarding zone router 107, a trunk router 105 may reserve a moving position-target for a vehicle that is departing from the boarding zone associated with the boarding zone router 107 and convey that reservation to the boarding zone router 107. The trunk router 105 may maintain a record of all moving position-target reservations and the vehicles to which a moving position-target is assigned.

Boarding zone routers 107 may manage vehicle departures and arrivals at associated boarding zones. Boarding zone routers 107 may determine when vehicles can depart from parking spots in order to begin a trip, and when vehicles can enter parking spots in order to conclude a trip. A boarding zone router 107 may perform trajectory deconfliction within an associated boarding zone, and may use the results of the trajectory deconfliction to determine when vehicles can travel through the boarding zone. For example, a boarding zone router 107 may compare a proposed trajectory segment of a vehicle that is waiting to depart to other known trajectories through the boarding zone, and may instruct the vehicle to depart once it determines that its proposed trajectory segment is deconflicted. Boarding zone routers 107 may also request moving position-targets from trunk routers that manage trunk lanes that are connected to the boarding zone (and on which a vehicle is assigned to travel). The boarding zone routers 107 may then determine a vehicle departure time, trajectory, and/or other vehicle operational parameters for a departing vehicle based on the particular moving position-target that is assigned to (e.g., reserved for) that vehicle.

The control system 101 may also include one or more track monitoring systems (TMS) 106. The track monitoring systems 106 may be positioned at various locations within the transportation system, including along roadways, boarding zones, at storage and maintenance facilities, and the like. The TMS 106 may include sensing systems to detect various conditions and events within the system. The sensing systems may include high-resolution (e.g., 0.2-2 mrad), low-latency (<100 ms), long-range (>600 feet) tri-band redundant sensing systems (lidar, radar, camera), and dual-band redundant wireless communication systems. The TMS 106 may provide automated system monitoring including automated vehicle monitoring and automated intrusion detection and may monitor for and provide low-latency response to any violations of system safety invariants. In some cases, track monitoring systems 106 may be deployed at intervals along a roadway, such as every 140-320 feet along the roadway. The particular interval may depend on geographical conditions, roadway properties (e.g., straights vs. turns vs. elevation changes), etc. Track monitoring systems 106 may also be deployed at boarding zones, maintenance and storage facilities, and the like. In some cases, every location in the transportation system that allows for vehicle travel may include one or more TMS 106.

The transportation system 110 also includes autonomous vehicles 108. The autonomous vehicles 108 may be autonomous or semi-autonomous vehicles specifically designed for use with the transportation system 110. One example type of vehicle 108 is described with respect to FIGS. 13A-15B, though other types of vehicles may be included instead of or in addition to those described herein. The vehicles 108 may be configured to independently and at least semi-autonomously (including fully autonomously) operate according to particular vehicle control schemes established for particular roadway segments and/or other transportation system infrastructure. While certain aspects of vehicle operation may be fully controlled by the vehicle itself, other aspects may be controlled and/or determined by the CMS 102 or the control system 101 more generally. For example, the control system 101 may provide deconflicted vehicle trajectories to the autonomous vehicles 108, and the vehicles may perform vehicle operations (e.g., steering, accelerating, braking, etc.) in order to maintain coincidence with the parameters defined by the trajectories (e.g., position, velocity, acceleration). The autonomous vehicles 108 may also be configured to monitor and account for safety issues such as obstacles, roadway or environmental conditions, etc., and optionally take appropriate evasive or other safety measures, while traversing a trajectory.

In some embodiments, the control system 101 (e.g., a trunk router 105 working with the CMS 102) may control a set of autonomous vehicles navigating along a section of the roadway by providing a set of moving position-targets, managing the set of moving position-targets, and/or assigning vehicles to moving position-targets. The control system 101 (e.g., via the TMS 106 and/or the CMS 102) may determine that the first moving position-target interferes with a priority path for a second vehicle. As used herein, a priority path may correspond to a spacetime trajectory, or a portion of a spacetime trajectory, of a vehicle or of a moving position-target that has a right-of-way priority relative to other vehicles. The priority path may generally correspond to the space that a vehicle will occupy (and/or an envelope around the vehicle) during at least a portion of the vehicle's traversal of a roadway. The transportation system 110 may represent priority paths in various ways. For example, as described herein, a priority path (or a portion thereof) may be represented by an exclusion area associated with a vehicle, where the vehicle has the priority right-of-way (at least along a particular section of roadway). As another example, a priority path may be represented as a portion of a spacetime trajectory. In some cases, the transportation system may implement multiple priority or right-of-way levels, such that a particular vehicle may have priority (e.g., right-of-way priority) over another vehicle, while other vehicles may have priority over the particular vehicle. While examples herein are described with respect to two priorities, it will be understood that even the vehicles described herein as being associated with priority paths or otherwise having right-of-way priority may be treated as a lower priority vehicle under certain conditions (and in such cases may act in the same or similar manner as the lower-priority vehicles described in the various examples).

The control system 101 (e.g., the trunk router 105) may then determine (e.g., generate) a revised moving position-target for the first vehicle. The revised moving position-target may be configured so that the first vehicle avoids the priority path. The control system 101 (e.g., the TMS 106) may then transmit route information corresponding to the revised moving position-target, causing the first vehicle to follow the revised moving position-target and avoid the priority path. In some embodiments, the control system 101 (e.g., using the TMS 106) may continue to monitor the second vehicle and adjust a trajectory (e.g., a spacetime trajectory) of the first vehicle as needed to avoid the priority path, including assigning or reassigning the first vehicle to further revised moving position-targets. In some embodiments, the second vehicle may be associated with an exclusion area, the second vehicle having right-of-way priority along the priority path. The control system 101 (e.g., the TMS 106) may store information regarding the exclusion area, and use the stored information as needed to control the first vehicle to avoid or be removed from (exit) the exclusion area of the second vehicle. In some embodiments, the control system 101 (e.g., the TMS 106) may be used to monitor the second vehicle and the associated exclusion area for intrusions, including the presence of a first vehicle in or near (e.g., within a threshold distance and/or headway) of the exclusion area.

As used herein, a revised moving position-target may be understood as a separate moving position target that may be assigned to a vehicle (or to which a vehicle may be assigned), or as a revision to the data that defines a moving position-target. Generally and broadly, a revised moving position-target may represent a moving position target with a predetermined spacetime trajectory that is different than the predetermined spacetime trajectory of an original moving position-target.

As used herein, interferences between vehicles and/or moving position-targets may refer to interactions that violate one or more operational constraints. For example, interferences may correspond to overlaps in physical spacetime. Stated another way, if multiple entities (e.g., moving position-targets and exclusion areas, vehicles and moving position-targets, two or more moving position-targets, etc.) overlap in physical spacetime (e.g., occupy the same space at the same time), they may be interfering. A determination that entities interfere may be based on actual interference (e.g., a moving position-target and/or a vehicle is currently within an exclusion area), or a predicted interference (e.g., a moving position-target and/or vehicle will overlap an exclusion area, another moving position-target, or another vehicle if all entities continue along their current and/or assigned trajectories). In some implementations, interferences need not correspond to or otherwise indicate physical contact, but may correspond to or indicate overlapping of exclusion areas, predetermined vehicle separation minimums, or the like.

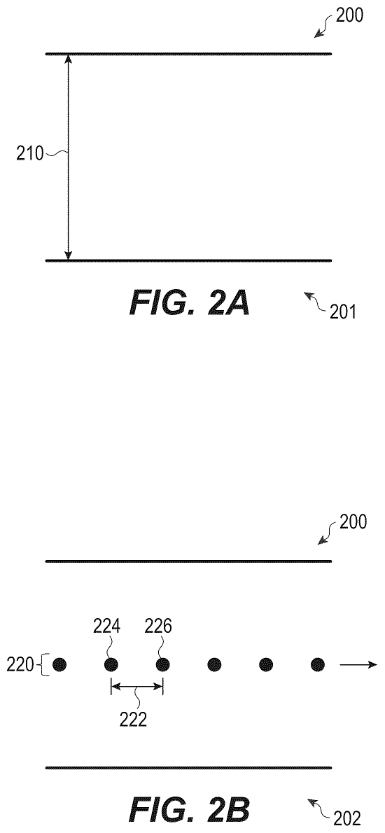

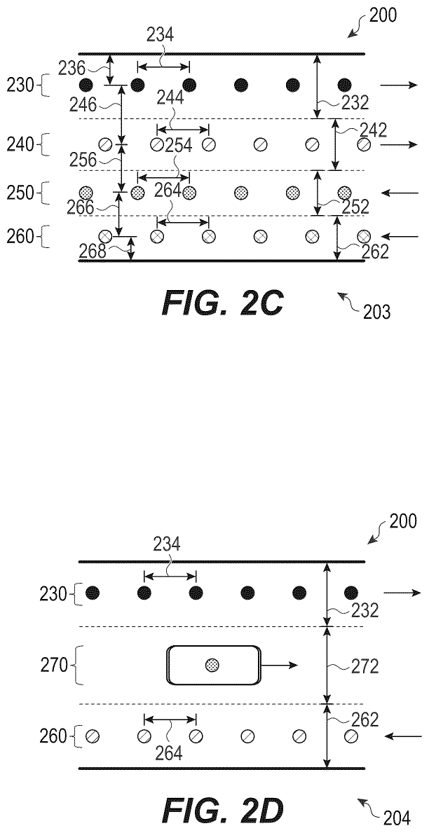

FIG. 2A depicts an example of a configuration 201 of a section of roadway 200 of a transportation system, such as the transportation system 110 controlling the vehicles 108, that may be used to support scalable autonomous vehicle roadways in a transportation system. Roadway 200 may have a width 210, and be constructed from any suitable material for use by vehicles as described herein, such as asphalt, concrete, gravel, stone, brick, and so on. In some embodiments, roadway 200 may lack lane or other guidance markings on the roadway 200. For example, such markings may not be needed in a transportation system using autonomous vehicles that are controlled to follow moving position-targets. In other embodiments, roadway 200 may include such markings, for example to facilitate use by non-autonomous vehicles when operating on a roadway shared with autonomous vehicles (that do not require such markings) in the transportation system.

For clarity and to facilitate discussion, only a short section of the roadway 200 is shown. However, it should be appreciated that the roadway may continue over longer distances, vary in widths at different locations along the roadway, have branches, split into multiple roadways, have feeder roadways, merge with another roadway, or otherwise deviate from a single-width roadway. Additionally, certain portions of roadway 200 may include or be associated with additional features such as boarding zones for autonomous vehicles, parking facilities (e.g., parking lots, parking garages), maintenance facilities, intersections, merging zones, and the like.

FIG. 2B depicts an example of a configuration 202 of the section of roadway 200 configured for continuous vehicle flow, for example associated with a moving position-target control scheme. A moving position-target control scheme can define the motions and positions of vehicles on the roadway. In particular, the configuration 202 may have a set of moving position-targets 220 configured for the roadway 200 according to a moving position-target control scheme. Note that only a subset of the total set of moving position-targets 220 are shown for clarity. A single moving position-target 224 may be spaced from a next moving position-target 226 by a headway 222. The value of the headway 222 may be a fixed distance, or may depend on a speed or velocity of a given moving position-target of the set of moving position-targets. In some cases, the value of the distance 222 is defined by a particular headway, which may be based, at least in part, on a predetermined safe following condition (which may in turn be based on vehicle braking performance, traction, and other vehicle and/or environmental parameters). In some cases, the headway is about 3 seconds, about 4 second, about 5 seconds, or a different duration. Stated another way, a headway of a certain time may correspond to different distances at different vehicle speeds (e.g., smaller distances at lower speeds). Thus, a trailing vehicle following a leading vehicle at a constant headway of 3 seconds may trail the leading vehicle by a first distance when the vehicles are travelling at a first speed, and at a second, greater, distance when the vehicles are travelling at a second, greater, speed. In both circumstances, the headway may remain at or about 3 seconds.

FIG. 2C depicts an example of a configuration 203 of the section of roadway 200 configured for continuous vehicle flow in multiple lanes, for example associated with a moving position-target control scheme. The configuration 203 may have a first set of moving position-targets 230, a second set of moving position-targets 240, a third set of moving position-targets 250, and a fourth set of moving position-targets 260 configured for the roadway 200 according to a moving position-target control scheme. Note that only a subset of the total set of moving position-targets are shown for clarity.

For the section of roadway 200, four lanes may exist (at least functionally and/or operationally) for the four sets of moving position-targets: a first lane having a width 232 for the first set of moving position-targets 230; a second lane having a width 242 for the second set of moving position-targets 240; a third lane having a width 252 for the third set of moving position-targets 250; and a fourth lane having a width 262 for the fourth set of moving position-targets 260. As noted herein, physical marking or indications of such lanes need not exist on the section of the roadway 200, such that any lane width may merely be a consequence of the transportation system setting positions for each of the sets of moving position-targets that are spaced apart from other sets of moving position-targets. For example, in some embodiments, the transportation system may configure the first set of moving position-targets 230 to be a distance 236 from a first edge of the roadway 200 (e.g., a physical or logical edge), and the fourth set of moving position-targets 260 to be a distance 268 from a second edge (e.g., a physical or logical edge) of the roadway 200. At the section of roadway 200, the fourth set of moving position-targets 260 may be a distance of 266 from the third set of moving position-targets 250, which in turn may be a distance of 256 from the second set of moving position-targets 240, which may in turn be a distance of 246 from the first set of moving position-targets 230. While each of these distances may be greater than a minimum distance between a set of moving position-targets, as established within the transportation system, any given path for a set of moving position-targets may be defined by the transportation system by positions and associated position information for the respective set of moving position-targets.

According to the exemplary configuration 203, two of the sets of moving position-targets (the first set of moving position-targets 230 and the second set of moving position-targets 240) are moving in one direction, while two of the sets of moving position-targets (the third set of moving position-targets 250 and the fourth set of moving position-targets 260) are moving in an opposite direction. Each moving position-target may be spaced from a next moving position-target by a headway 234 for the first set of moving position-targets 230, a headway 244 for the second set of moving position-targets 240, a headway 254 for the third set of moving position-targets 250, and a headway 264 for the fourth set of moving position-targets 260. The value of a headway between moving position-targets may be fixed, or may depend on a speed or velocity of a given moving position-target of the set of moving position-targets, whether the moving position-targets are moving in a straight line or turning, and so on. The headway between moving position-targets in different lanes may be the same or they may differ.

FIG. 2D depicts an example of a configuration 204 of the section of roadway 200 configured for continuous vehicle flow, for example associated with a moving position-target control scheme. The roadway 200 may have the first set of moving position-targets 230 and the fourth set of moving position-targets 260 configured for the roadway 200 according to the configuration as described with reference to configuration 203. Note that only a subset of the total set of moving position-targets are shown for clarity.

The configuration 204 may support a fifth set of moving position-targets 270. For example, relatively larger vehicles than the vehicles supported by or otherwise utilizing the first set of moving position-targets 230 or the fourth set of moving position-targets 260, may use the fifth set of moving position-targets 270. As an example, such vehicles may include transit vehicles or other large vehicles.

The roadway 200 according to configuration 203 may be at a first time and the roadway 200 according to configuration 204 may be the same roadway 200 at a second time. For example, the single, larger lane for the set of moving position-targets 270 may operate in a width 272 of the roadway 200 previously occupied by the width 242 and the width 252. Under the direction of control system 101, the width 232 and the width 262 may remain the same between the first time and the second time, as illustrated. In other examples, the widths may be different. Under the control of the control system 101, the effective widths (the width 232, the width 262, and the width 272) for configuration 204 may be different than for configuration 203. Because the roadway 200 lacks markings or other indicators, and the autonomous vehicles are following a moving position-target, and not a visible, physical lane marking or indicator, the widths (and indeed the number of lanes, the direction of travel in the lanes, etc.) may be varied as desired or needed.

Similarly, the headway between adjacent moving position-targets may be varied at different times. For example, where an increased quantity or percentage of the sets of moving-position targets are occupied, the headway may be increased. As another example, where a lane width (e.g., width 232) is reduced, a headway between moving-position targets may also be reduced. In embodiments, based on the presence or absence of a higher priority vehicle following a moving position-target of the set of moving position-targets 270, the width 232 for the first set of moving position-targets 230 and/or the width for the fifth set of moving position-targets 270 may be increased or decreased.

Generally and broadly, FIGS. 2A-2D illustrate how lanes may be dynamically varied to accommodate different vehicle operations along a section of roadway. Notably, since the lanes are logically defined (e.g., rather than strictly following physical lane markings), the roadway may be utilized in numerous manners, depending on the particular needs of the transportation system and/or its users. For example, the amount and size of the lanes along the roadway may be dynamically changed in response to various conditions. Additionally, the manner in which vehicles are controlled in any given lane may be selected or changed to suit different conditions. For example, in some instances, all lanes may be controlled according to a moving position-target control scheme, while in other instances, one or more first lanes may implement moving position-target control while one or more second lanes may be usable by un-controlled traffic (e.g., non-autonomous and/or human operated vehicles).

As described herein, the system may modify the lane configuration of the roadway to satisfy myriad conditions or transportations system objectives. For example, the transportation system may increase the number of lanes in order to increase throughput along a section of roadway. As another example, the transportation system may decrease the number of lanes to allow greater separation distances between vehicles (e.g., to allow greater operating speeds with the same headway, during times of adverse weather events, or the like). As another example, the transportation system may instantiate an additional lane of higher-speed moving position-targets to accommodate vehicles having a different priority level. As yet another example, the transportation system may instantiate “partial” lanes (e.g., lane segments that appear and/or collapse around a single vehicle) in order to provide priority lane access for individual vehicles (e.g., emergency response vehicles such as firefighting vehicles, ambulances, police vehicles, etc.). These and other techniques and operations are described herein.

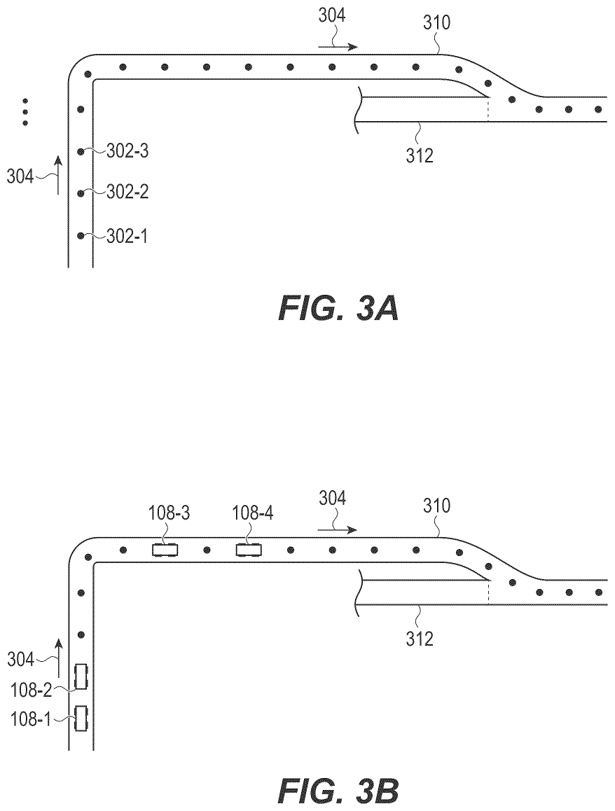

FIGS. 3A and 3B illustrate an example portion of a trunk lane 310 and a boarding zone 312, illustrating features of the moving position-target control scheme, and how vehicles may enter the trunk lane 310 from a boarding zone 312.

With reference to FIG. 3A, in a moving position-target control scheme, vehicles on the trunk lane 310 are configured to follow moving position-targets 302 (e.g., 302-1, . . . , 302-n) that move, virtually, along the trunk lane 310. For example, the moving position-targets 302 (also referred to herein simply as position targets) may be conceptualized as virtual points that move along the trunk lane 310 and that the vehicles will attempt to remain “on” as they navigate along the trunk lane. In this way, the manner in which the moving position-targets 302 (and thus the vehicles) move along the trunk lane may be predefined for the trunk lane, and any vehicle that drives along the trunk lane in accordance with the moving position-target control scheme will move in a predictable, predetermined manner (e.g., at a position, velocity, acceleration, etc., that is predefined by the moving position-targets). As shown in FIG. 3A, the moving position-targets 302 move along a direction indicated by arrows 304. Moving position-targets may be predefined (e.g., by trunk routers) for the roadway, and may be defined regardless of whether a vehicle is occupying or following them.

As described herein, the position targets need not have a fixed speed or fixed separation headway along a trunk lane. Rather, such parameters may vary to accommodate various needs of the transportation system. For example, the velocity of the position targets may change (e.g., decrease) around a turn in the trunk lane, and the distance between the position targets may also change (e.g., decrease) around the turn. Even where speeds and/or following distances change in a moving position-target control scheme, the flow rate of vehicles may remain constant along the trunk lane, thus enabling steady-state operation of the system and avoiding backups or other non-steady state conditions.

The moving position-targets 302 may be defined in any suitable manner. For example, the moving position-targets 302 may be defined by functions that define position, velocity, and acceleration along the trunk lane as a function of time. Each vehicle may be provided with (or generate based on other information) a representation (e.g., a parametric representation, a function) of its assigned moving position-target 302 so that each vehicle can independently attempt to maintain the position, velocity, and acceleration values defined by the function. Thus, for example, a vehicle may follow a position target by using the particular parametric representation (or other function defining position, velocity, and acceleration with respect to time) that is provided to and/or generated by the vehicle. As used herein, assigning a moving position-target to a vehicle may include (or result in) a vehicle being provided with the representation of the moving position-target, and/or information from which a representation of the moving position-target may be generated.

As used herein, a vehicle “following” a position target refers to the vehicle attempting to maintain its position at the virtual position target (or at a fixed offset from the position target), and does not require that the vehicle be behind the position target. For example, a vehicle may “follow” the position target by using closed-loop controllers that control the steering and propulsion systems of the vehicle to minimize an error between the vehicle's actual position, velocity, and acceleration and the prescribed position, velocity, and acceleration (as defined by a parametric representation, for example). As would be expected in a closed-loop control system, the actual motion parameters of the vehicle may deviate slightly from the prescribed parameters, and as such the actual motion parameters may not be exactly equal to the prescribed parameters during normal operations of the system. Thus, following, tracking, or otherwise maintaining coincidence with a position target will be understood to include the potential of such incidental errors.

FIG. 3B illustrates the portion of the trunk lane 310 at a time t₀ in which vehicles 108-1, 108-2, 108-3, and 108-4 are travelling along the trunk lane 310. As shown in FIG. 3B, each vehicle is coincident with a respective position target (e.g., the vehicle 108-1 is coincident with the moving position-target 302-1, the vehicle 108-2 is coincident with the moving position-target 302-2). The vehicles may be configured to follow their respective position targets as the position targets move along the trunk lane 310 in the direction indicated by arrows 304. For example, as described above, the vehicles 108 may implement a closed-loop control scheme in which the position, velocity, and acceleration of the moving position-targets 302 are used as position, speed, and acceleration setpoints for the vehicles, and the vehicles 108 follow the moving position-targets 302 by attempting to minimize or reduce the error between the position targets and the actual position of the vehicle.

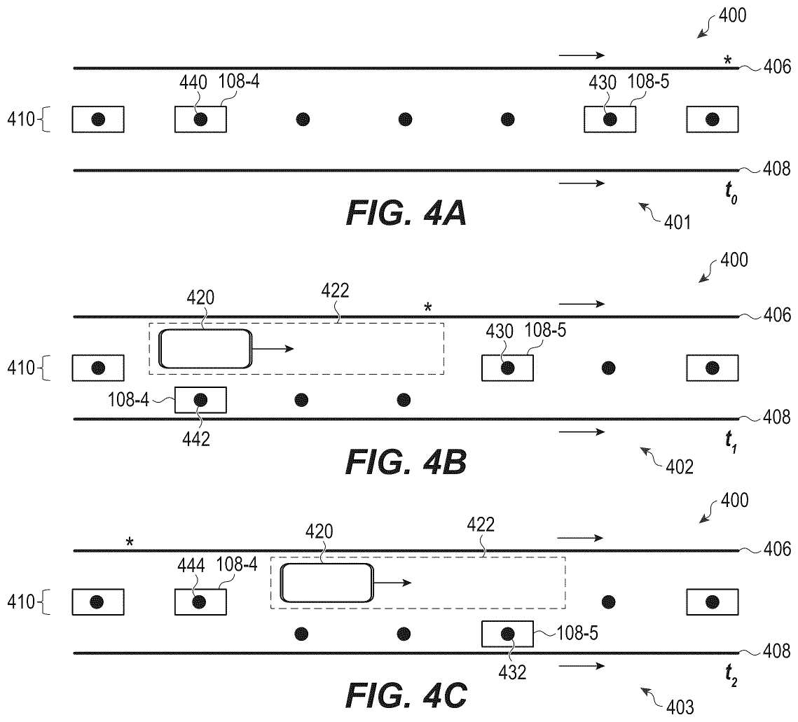

FIGS. 4A-4C generally depict a roadway operating with dynamic lane configurations. More particularly, FIGS. 4A-4C depict an example of vehicles shifting to one side to allow a priority vehicle to pass. FIGS. 4A-4C illustrate an example of how lane configurations may be dynamically controlled on a roadway to accommodate various arrangements of vehicles, and more particularly, how lanes (even partial lanes) may be allocated and deallocated (e.g., created and destroyed) dynamically, depending on the locations of the vehicles, their assigned position targets, vehicle priorities and/or rights-of-way, and the like.

FIG. 4A depicts an example of a configuration 401 of a section of roadway 400 of a transportation system, such as the transportation system 110 controlling the vehicles 108, that may be used to support scalable autonomous vehicle roadways in a transportation system. Roadway 400 may be an example of and include features of any of the roadways described herein, including roadway 200. At a first time (t₀), the configuration 401 includes a roadway 400 having an edge 406 and an edge 408 (e.g., physical or logical edges). The roadway 200 at to, as illustrated, is operating with a single lane of continuous unidirectional traffic.

The transportation system 110, for example the control system 101, may control the movement of vehicles along the roadway 400 according to a set of moving position-targets 410. In particular, a vehicle 108-4 may follow (track) a moving position-target 440 of the set of moving position-targets 410. For example, the vehicle 108-4 may be provided with a function representing the position of the moving position-target 440 over time, which position the vehicle 108-4 follows. Similarly, a vehicle 108-5 may follow a moving position-target 430 of the set of moving position-targets 410. As depicted, moving position-targets may be represented by dots or circles. Occupied moving position-targets may be shown surrounded by a rectangular outline (indicating the presence of a vehicle), while unoccupied moving position-targets may be shown without a rectangular outline.

FIG. 4B depicts an example of a configuration 402 of the section of roadway 400 of the transportation system at a second time (t₁). At t₁, a vehicle 420 having a right-of-way priority has entered the section of the roadway 400 that includes the set of moving position-targets 410. In this example, the vehicle 420 has a greater speed (e.g., higher velocity) relative to the set of moving position-targets 410, and thus has a greater speed than the vehicles following moving position-targets of the set of moving position-targets 410, including vehicle 108-4 and vehicle 108-5. Associated with the vehicle 420 is an exclusion area 422. As depicted, moving position-targets that would otherwise be present are not shown within the exclusion area 422. In particular, the transportation system 110 may remove, deactivate, block, or otherwise not use unoccupied moving position-targets that interfere with an exclusion area 422. This may prevent the transportation system 110 from assigning vehicles to moving position-targets that are not available (e.g., because they interfere with an exclusion area or another vehicle).

The transportation system 110 may determine a priority path of the vehicle 420, which the exclusion area 422 may extend along and/or be at least partially defined by. Having determined that the vehicle 108-4 at the moving position-target 440 would interfere with the exclusion area 422, the transportation system 110 may determine a revised moving position-target 442 for the vehicle 108-4. In some examples, the revised moving position-target 442 may be closer to an edge 408 of the roadway 400 than the moving position-target 440. At t₁, the vehicle 108-4 has received route information corresponding to this revised moving position-target 442, and the vehicle 108-4 has navigated to the revised moving position-target 442 to avoid the exclusion area 422 as the vehicle 420 moves along the priority path (e.g., its spacetime trajectory which has right-of-way priority over the moving position-targets 410).

With reference to the vehicle 108-5, at t₁, the vehicle 108-5 may not yet be close enough to the exclusion area 422 of the vehicle 420 to be determined to interfere with such exclusion area 422. As such, the vehicle 108-5 may continue to follow the moving position-target 430. By allowing vehicles that are not yet in conflict with the exclusion area to continue without altering their moving position-targets, the extent of a disturbance on the overall system due to a passing higher priority vehicle may be reduced or minimized.

FIG. 4C depicts an example of a configuration 403 of the section of roadway 400 of the transportation system at a third time (t₂). At t₂, the vehicle 420 has proceeded forward relative to the set of moving position-targets 410 along the priority path of the vehicle 420. As a result of this movement, the transportation system 110 may detect or otherwise determine that the exclusion area 422 of the vehicle 420 has passed the vehicle 108-4 and also that the vehicle 108-5 interferes with the exclusion area 422.

Having detected or otherwise determined that the exclusion area 422 of the vehicle 420 has passed the vehicle 108-4, the transportation system 110 may communicate to the vehicle 108-4 an indication of an available moving position-target 444 for the vehicle 108-4. In some examples, the available moving position-target 444 may be further from the edge 408, and closer to the edge 406, than the revised moving position-target 442. In some examples, and as illustrated with reference to the configuration 403, the available moving position-target 444 for the vehicle 108-4 may return the vehicle 108-4 to a position within the set of moving position-targets 410 (which are moving) that is equivalent to moving position-target 440 that the vehicle 108-4 was following at time t₀. In other examples, the available moving position-target 444 for the vehicle 108-4 may be a different moving position-target of the set of moving position-targets 410.

At t₂, the transportation system 110 has determined that the vehicle 108-5 at the moving position-target 430 would interfere with the exclusion area 422 of the vehicle 420. As such, the transportation system 110 may determine a revised moving position-target 432 for the vehicle 108-5. At t₂, the vehicle 108-5 has received route information corresponding to this revised moving position-target 432, and the vehicle 108-5 has navigated to the revised moving position-target 432 to avoid the exclusion area 422 as the vehicle 420 moves along the priority path. In some embodiments, the revised moving position-target 432 is closer to the edge 408 of the roadway 400 than the moving position-target 430.

FIGS. 4A-4C illustrate how a second lane may be dynamically allocated (e.g., instantiated) in a roadway section being operated as (or otherwise including) a single lane in order to accommodate another vehicle. As shown the second lane exists only in a certain area where vehicles are in proximity to each other. For example, the second lane may generally correspond to the exclusion area 422 of the vehicle 420, and may traverse the roadway in synch with the vehicle 420. Further, as shown, the transportation system 110 may adjust both occupied and unoccupied moving position-targets of the primary lane based on the location of the exclusion area 422. Thus, the two “lanes” (e.g., the primary lane and the moving, partial lane of the exclusion area) may be functionally instantiated regardless of whether the moving position-targets are occupied at a given time. This also allows the transportation system 110 to assign vehicles to the adjusted or shifted moving position-targets at any time and without risking adverse interactions between the various vehicles, since the shifted moving position-targets already conform to the logical multi-lane configuration (and are thus already deconflicted with respect to the exclusion area).

Although shown as straight, the exclusion area 422 and the section of the roadway 400 need not be straight. For example, where the roadway 400 curves around a bend, the exclusion area 422 may similarly curve around the bend, along the priority path of the vehicle 420. Similarly, although shown as rectangular shaped, the exclusion area 422 may take on alternative shapes. For example, the exclusion area 422 may be an oval or other curved shape, or a polygon other than a rectangle. The exclusion area 422 may be defined with reference to the vehicle 420, with reference to the roadway 400, or with reference to some combination of the vehicle 420 and the roadway 400. The exclusion area 422 may encompass and/or surround the vehicle 420, and may extend a distance ahead of the vehicle, a distance behind the vehicle, and a distance to the sides of the vehicle. In some cases, different vehicles, vehicle types, vehicle classes, or vehicle priority levels are associated with differently sized and/or shaped exclusion areas 422.

In one or more embodiments, the vehicle 420 may be an emergency response vehicle. In other embodiments, the vehicle 420 may be a mass transit vehicle. As illustrated and discussed with reference to the configuration 401, the configuration 402, and the configuration 403, the vehicle 420 may be a non-autonomous vehicle. In other embodiments, the vehicle 420 may be an autonomous vehicle, whether controlled by the transportation system 110 (e.g., using a set of moving position-targets that are not shown) or a different transportation system according to a set of moving position-targets or via a different control or management structure or system.

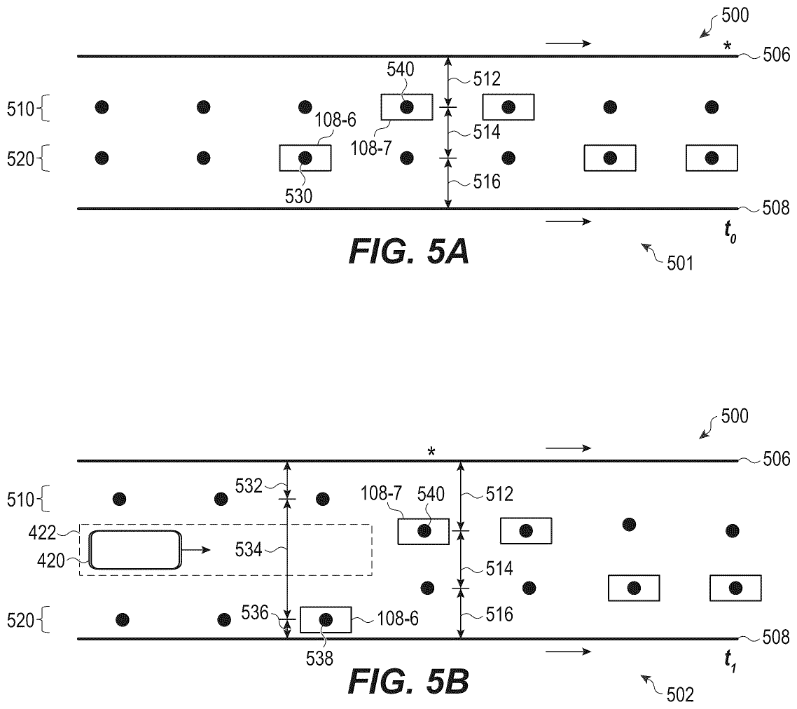

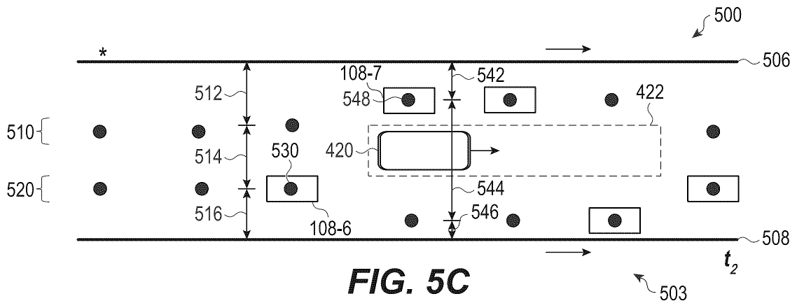

FIGS. 5A-5C generally depict a roadway operating with dynamic lane configurations. More particularly, FIGS. 5A-5C depict an example of a flow of vehicles separating to provide a priority vehicle to pass in an interstitial position or lane of the roadway. FIGS. 5A-5C illustrate an example of how lane configurations may be dynamically controlled on a roadway to accommodate various arrangements of vehicles, and more particularly, how lanes (even partial lanes) may be allocated and deallocated (e.g., created and destroyed) dynamically, depending on the locations of the vehicles, their assigned position targets, vehicle priorities and/or rights-of-way, and the like.

FIG. 5A depicts an example of a configuration 501 of a section of roadway 500 of a transportation system, such as the transportation system 110 controlling the vehicles 108, that may be used to support scalable autonomous vehicle roadways in a transportation system. Roadway 500 may be an example of and include features of any of the roadways described herein, including roadway 200 or roadway 400. At a first time (t₀), the configuration 501 includes a roadway 500 having an edge 506 and an edge 508 (e.g., physical or logical edges). The roadway 500 at to, as illustrated, is operating with two lanes of continues unidirectional traffic.

The transportation system 110, for example the control system 101, may control the movement of vehicles along the roadway 500 according to two sets of moving position-targets: a first set of moving position-targets 510 and a second set of moving position-targets 520. In some embodiments, the different sets of moving position-targets may move at different speeds. In other embodiments, the different sets of moving position-targets may move in different directions.

In some examples, a vehicle 108-6 may follow (track) a moving position-target 530 of the second set of moving position-targets 520. For example, the vehicle 108-6 may be provided with a function representing the position of the moving position-target 530 over time, which the vehicle 108-6 follows as described herein. At to, the moving position-targets, including moving position-target 530 of the second set of moving position-targets 520, are spaced a distance 516 from the edge 508 of the roadway 500. The moving position-target 530 is spaced 514 from moving position-targets of the first set of moving position-targets 510, which are in turn spaced a distance 512 from the edge 506.

Similarly, a vehicle 108-7 may follow (track) a moving position-target 540 of the first set of moving position-targets 510. The vehicle 108-7 may be provided with a function representing the position of the moving position-target 540 over time, which the vehicle 108-7 follows as described herein.

FIG. 5B depicts an example of a configuration 502 of the section of roadway 500 of the transportation system at a second time (t₁). At t₁, a vehicle 420 having a right-of-way priority has entered the section of the roadway 500 that includes the sets of moving position-targets 510 and moving position-targets 520. In this example, the vehicle 420 has a greater speed (e.g., higher velocity) relative to the set of moving position-targets 510 and/or the set of moving position-targets 520, and thus a greater speed than the vehicles following the set of moving position-targets 510 and/or the set of moving position-targets 520, including vehicle 108-6 and vehicle 108-7.

Associated with the vehicle 420 is an exclusion area 422. The transportation system 110 may determine a priority path of the vehicle 420, and the exclusion area 422 may extend along the priority path (in addition to other directions around the vehicle). For example, the exclusion area 422 may extend forward of the vehicle 420 along the direction of travel of the vehicle 420. The forward part of the exclusion area 422 may be used by the transportation system to determine where a partial lane should be instantiated and/or to identify which vehicles and/or moving position-targets should be modified in order to instantiate a lane or partial lane. As described herein, the exclusion area 422 may also extend laterally and rearward of the vehicle.

Having determined that the vehicle 108-6 at the moving position-target 530 would interfere with the exclusion area 422, the transportation system 110 may determine a revised moving position-target 538 for the vehicle 108-6. In some examples, the revised moving position-target 538 may be closer to an edge 508 of the roadway 500 than the moving position-target 530 (in FIG. 5A). At t₁, the vehicle 108-6 has received route information corresponding to this revised moving position-target 538, and the vehicle 108-6 has navigated to the revised moving position-target 538 to avoid the exclusion area 422 as the vehicle 420 moves along the priority path. At t₁, the moving position-targets that are proximate the exclusion area 422 have shifted to instantiate an additional lane (e.g., a partial lane) for the vehicle 420. For example, at t₁, the moving position-target 538 (as well as the other shifted moving position-targets along the bottom side of the exclusion area 422 (e.g., to the vehicle's right, towards the bottom of the page)), are spaced a distance 536 from the edge 508 of the roadway 500. The moving position-target 538 (as well as the other shifted moving position-targets along the bottom side of the exclusion area 422) is spaced a distance 534 from the shifted moving position-targets along the top side of the exclusion area 422 (e.g., to the vehicle's left), which are in turn spaced a distance 532 from the edge 506. At t₁, the distance 534 is wide enough to accommodate the vehicle 420.

FIG. 5C depicts an example of a configuration 503 of the section of roadway 500 of the transportation system at a third time (t₂).

At t₂, the vehicle 420 having the right-of-way priority has proceeded further through the section of the roadway 500 that includes the sets of moving position-targets 510 and moving position-targets 520. As the exclusion area 422 of the vehicle 420 has passed the vehicle 108-6, route information may be provided to the vehicle 108-6 indicating for the vehicle 108-6 to return to the moving position-target 530 of the second set of moving position-targets 520 a distance 516 from the edge of the roadway 500.

Also, at t₂, the transportation system 110 may determine that the vehicle 108-7 interferes with the exclusion area 422 of the vehicle 420. Having determined that the vehicle 108-7 at the moving position-target 540 would interfere with the exclusion area 422, the transportation system 110 may determine a revised moving position-target 548 for the vehicle 108-7. The revised moving position-target 548 may be closer to an edge 506 of the roadway 500 than the moving position-target 540 (FIG. 5B). At t₂, the vehicle 108-7 has received route information corresponding to this revised moving position-target 548, and the vehicle 108-7 has navigated to the revised moving position-target 548 to avoid the exclusion area 422 as the vehicle 420 moves along the priority path. At t₂, the moving position-targets that are proximate the exclusion area 422 have shifted to instantiate the additional lane (e.g., a partial lane) for the vehicle 420. For example, at t₂ the moving position-target 548 (as well as the other shifted moving position-targets along the top side of the exclusion area 422 (e.g., to the vehicle's left)), are spaced a distance 542 from the edge 506 of the roadway 500. The moving position-target 548 (as well as the other shifted moving position-targets along the top side of the exclusion area 422) is spaced a distance 544 from the shifted moving position-targets along the bottom side of the exclusion area 422 (e.g., to the vehicles right), which are in turn spaced a distance 546 from the edge 508. At t₂, the distance 544 is wide enough to accommodate the vehicle 420.

FIGS. 5A-5C illustrate how an additional lane may be dynamically allocated (e.g., instantiated) in a roadway section being operated in a multi-lane scenario (or otherwise including multiple lanes) in order to accommodate another vehicle. As shown the third lane for the vehicle 420 exists only in a certain area where the vehicles are in proximity to each other. For example, the third lane may generally correspond to the exclusion area 422 of the vehicle 420, and may traverse the roadway in synch with the vehicle 420. Further, as shown, the transportation system 110 may adjust both occupied and unoccupied moving position-targets of the primary lane based on the location of the exclusion area 422. Thus, the three “lanes” (e.g., the two primary lanes and the moving, partial lane of the exclusion area) may be functionally instantiated regardless of whether the moving position-targets are occupied at a given time. This also allows the transportation system 110 to assign vehicles to the adjusted or shifted moving position-targets at any time and without risking adverse interactions between the various vehicles, since the shifted moving position-targets already conform to the logical multi-lane configuration (and are thus already deconflicted with respect to the exclusion area).

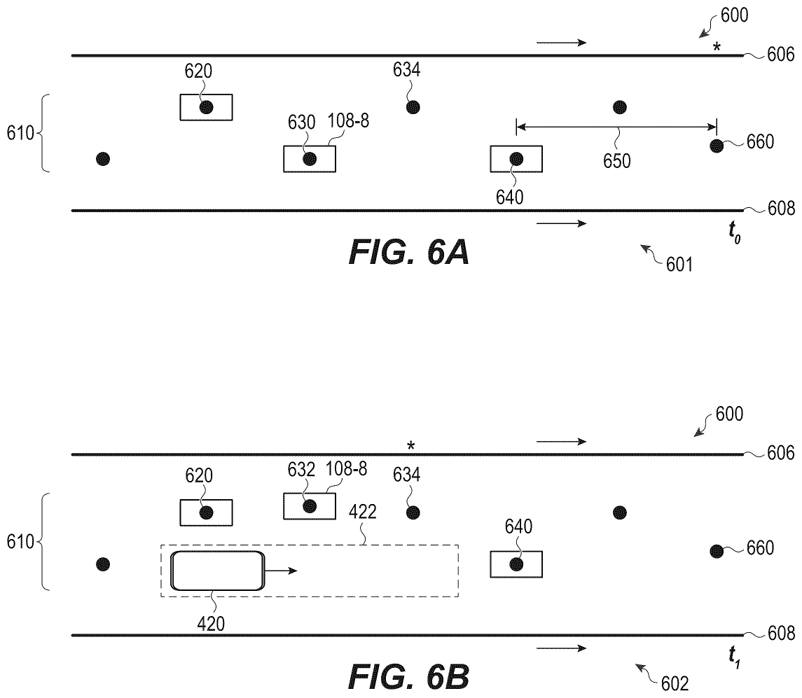

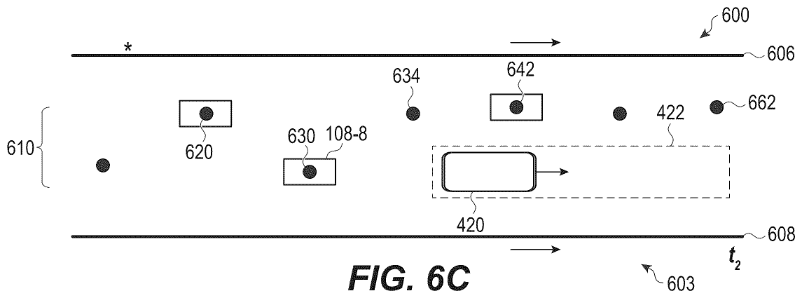

FIGS. 6A-6C generally depict a roadway operating with dynamic lane configurations. More particularly, FIGS. 6A-6C depict an example of vehicles in a staggered configuration of moving position-targets shifting to one side to allow a priority vehicle to pass. FIGS. 6A-6C illustrate an example of how lane configurations may be dynamically controlled on a roadway to accommodate various arrangements of vehicles, and more particularly, how lanes (even partial lanes) may be allocated and deallocated (e.g., created and destroyed) dynamically, depending on the locations of the vehicles, their assigned position targets, vehicle priorities and/or rights-of-way, and the like.

FIG. 6A depicts an example of a configuration 601 of a section of roadway 600 of a transportation system, such as the transportation system 110 controlling the vehicles 108, that may be used to support scalable autonomous vehicle roadways in a transportation system. Roadway 600 may be an example of and include features of any of the roadways described herein, including roadway 200, roadway 400, or roadway 500.

At a first time (t₀), the configuration 601 includes a roadway 600 having an edge 606 and an edge 608 (e.g., physical or logical edges). The set of moving position-targets 610 are arranged in a staggered pattern, and move in concert such that one moving position-target maintains its position relative to other moving position-targets. For example, moving position-target 620 will remain behind moving position-target 630 and moving position-target 640 as the set of moving position-targets 610 move along the roadway 600. The headway 650 between each two moving position-targets of the set of moving position-targets 610 (e.g., a leading and a following vehicle) is spaced such that a vehicle can be accommodated in between the two moving position-targets. Thus, a vehicle can be slotted into the space between two adjacent (in the direction of travel) vehicles to accommodate other vehicles and/or dynamically instantiate an at least partial lane.

FIG. 6B depicts an example of a configuration 602 for the roadway 600 at a second time (t₁). At t₁, the configuration 602 shows the moving position-target 630 (which the vehicle 108-8 is following) having been revised to be moving position-target 632 (which the vehicle 108-8 will follow). For example, the transportation system 110 may detect that the vehicle 108-8 associated with moving position-target 630 is (or will be) within the exclusion area 422 of the vehicle 420. The transportation system 110 may thus determine (e.g., instantiate) the revised moving position-target 632 which is between the moving position-target 620 and the moving position-target 634, and then transmit route information for the moving position-target 632 to the vehicle 108-8. As a result of receiving the route information for the moving position-target 632, the vehicle 108-8 slots in between the moving position-target 620 and the moving position-target 634 and follows the trajectory defined by the moving position-target 632. In this way, and as shown in FIG. 6B, a partial lane may be dynamically instantiated for the vehicle 420.

FIG. 6C depicts an example of a configuration 603 for the roadway 600 at a third time (t₂). At t₂, the transportation system 110 may detect that the exclusion area 422 associated with the vehicle 420 has passed the area of the moving position-target 632 such that the vehicle 108-8 may return to following the moving position-target 630. Other moving position-targets (e.g., the moving position-target 640) may be revised (e.g., the revised moving position-target 642) as the vehicle 420 having the exclusion area 422 proceeds.

As shown with reference to the configuration 603, in some embodiments, a moving position-target that is determined to conflict with an exclusion area of a higher priority vehicle may be revised regardless of whether a vehicle is currently following that moving position-target in the transportation system. For example, at t₂, the moving position-target 660 (FIGS. 6A, 6B) is revised to be moving position-target 662, even though no vehicle 108 is presently following the moving position-target 660 in the transportation system 110. In this way, the moving position-targets of the system may always be deconflicted with respect to other vehicles and/or moving position-targets. As such, vehicles can safely be assigned to any available moving position-target at any time (e.g., because each moving position-target will have been moved or revised, if necessary, to ensure there is no conflict with a priority or other vehicle).

While FIGS. 6A-6C illustrate vehicles slotting between pairs of vehicles travelling in-line in order to instantiate a partial lane for the vehicle 420, the same or similar operations of combining moving position-target sequences (e.g., merging two or more offset sequences of moving position-targets) may be used for various purposes when instantiating or uninstantiating lanes. For example, the transportation system may determine that a roadway being operated with two adjacent (and optionally staggered) sequences of moving position-targets is to be operated as a single lane. In response, the transportation system may merge the two sequences of moving position-targets as described with respect to FIGS. 6A-6C. The transportation system may merge lanes in this manner (or in another manner) in order to produce a single lane with a higher vehicle density, such as to allow a second lane of higher density to be populated on the same roadway.

In some cases, adjacent sequences of moving position-targets that are not staggered or otherwise positioned to merge together may be adjusted in order to achieve a desired vehicle and/or position target positioning. Once the vehicles and/or position targets are positioned so that they can be safely merged, the merge operation may occur substantially simultaneously along a desired length of roadway, such that an entire lane may be generated along a roadway section in a single operation. Since each vehicle will follow its updated position target, all vehicles on a particular sequence of position targets may merge substantially simultaneously. Sequences of position targets may be de-merged as well (e.g., reversing the merge operation to generate, from a single sequence of position targets, multiple parallel sequences of position targets or lanes). Such operations may be particularly advantageous for rapidly allocating and deallocating space on a roadway for multiple vehicles, and can allow throughput to be dynamically controlled, changed, and modified to achieve various results.

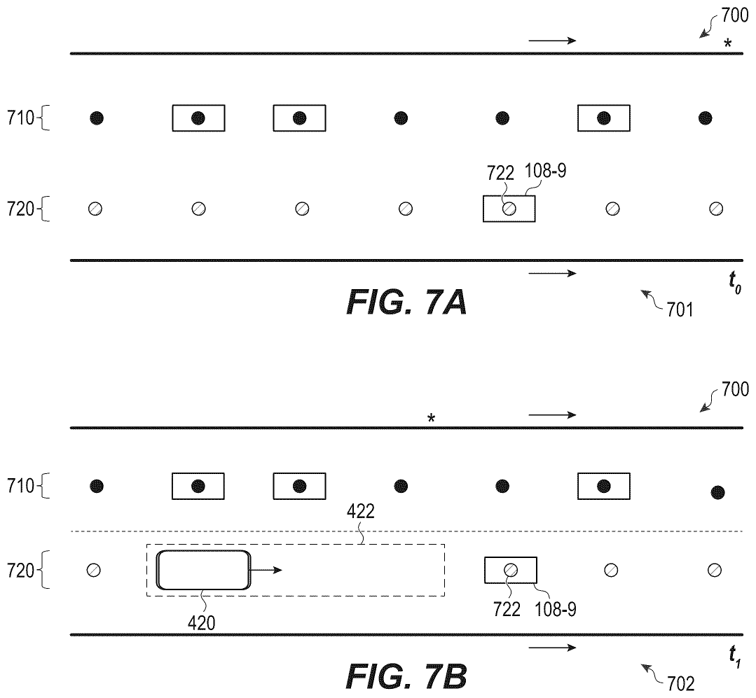

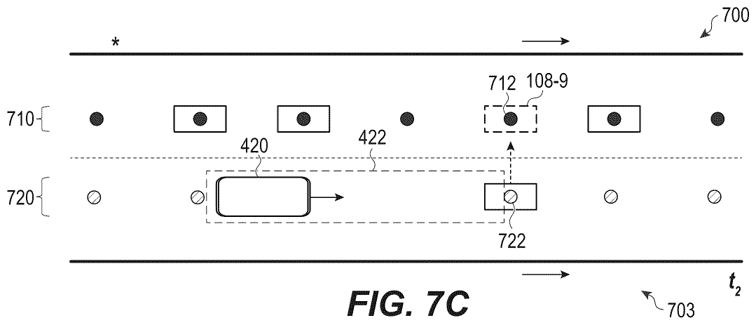

FIGS. 7A-7C generally depict a roadway operating with dynamic lane configurations. More particularly, FIGS. 7A-7C depict an example of two sets of moving position-targets, where vehicles of one set of moving position-targets move to moving position-targets of the second set of moving position-targets to allow a priority vehicle to pass.

FIG. 7A depicts an example of a configuration 701 of a section of roadway 700 of a transportation system, such as the transportation system 110 controlling the vehicles 108, that may be used to support scalable autonomous vehicle roadways in a transportation system. Roadway 700 may be an example of and include features of any of the roadways described herein, including roadway 200, roadway 400, roadway 500, or roadway 600.

At a first time (t₀), the configuration 701 includes both a first set of moving position-targets 710 and a second set of moving position-targets 720. As further described, vehicles (e.g., vehicles 108) of the transportation system may follow the moving position-targets of either the first set of moving position-targets 710 or the second set of moving position-targets 720. In some embodiments, the first set of moving position-targets 710 and the second set of moving position-targets 720 move at a same speed on the roadway 700 in a same direction. In other embodiments, the first set of moving position-targets 710 may proceed at a first speed and the second set of moving position-targets 720 may proceed at a second speed in a same direction.

FIG. 7B depicts an example of a configuration 702 for the roadway 700 at a second time (t₁). At t₁, the configuration 702 includes the moving position-target 722 (of the second set of moving position-targets 720) for a vehicle 108-9 to follow. A vehicle 420 having an exclusion area 422 may be proceeding along a priority path that follows the path of the second set of moving position-targets 720 (e.g., is travelling in the lane of the second set of moving position-targets 720). The vehicle 420 may also be following its own moving position-target or otherwise be following a predetermined spacetime trajectory. In other examples, the vehicle 420 may be manually (e.g., human) steered or piloted, may be self-driving but not following a moving position-target, or otherwise not controlled within a system that controls navigation using the sets of moving position-targets 710 and/or moving position-targets 720.

FIG. 7C depicts an example of a configuration 703 for the roadway 700 at a third time (t₂). At t₂, the transportation system (e.g., transportation system 110) has determined that the vehicle 108-9 that is following the moving position-target 722 interferes with the exclusion area 422 associated with the vehicle 420. Because the moving position-target 712 of the first set of moving position-targets 710 is next to (e.g., adjacent, or roughly adjacent or beside) the moving position-target 722 of the second set of moving position-targets, the transportation system may transmit route information to the vehicle 108-9 indicating for the vehicle to switch to following the moving position-target 712 as a result of determining that the vehicle 108-9 interferes with the exclusion area of the vehicle 420.

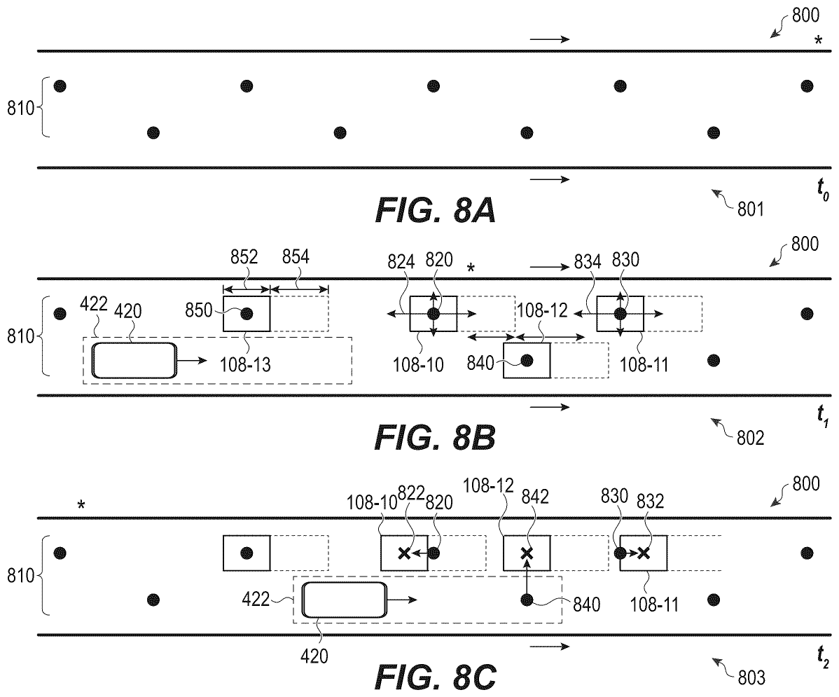

FIGS. 8A-8C generally depict an example of vehicles in a staggered configuration of moving position-targets shifting to one side to allow a priority vehicle to pass, where other vehicles may shift forward or backward in the roadway relative to their associated moving position-target to accommodate the revised moving position-target of a first vehicle.

FIG. 8A depicts an example of a configuration 801 of a section of roadway 800 of a transportation system, such as the transportation system 110 controlling the vehicles 108, that may be used to support scalable autonomous vehicle roadways in a transportation system. Roadway 800 may be an example of and include features of any of the roadways described herein, including roadway 200, roadway 400, roadway 500, roadway 600, or roadway 700.

At a first time (t₀), the configuration 801 includes a set of moving position-targets 810 that are arranged in a staggered pattern, and move in concert such that one moving position-target maintains its position relative to other moving position-targets of the set of moving position-targets 810.

FIG. 8B depicts an example of a configuration 802 for the roadway 800 at a second time (t₁). At t₁, the configuration 802 includes a vehicle 108-10 following a moving position-target 820, a vehicle 108-11 following a moving position-target 830, a vehicle 108-12 following a moving position-target 840, and a vehicle 108-13 following a moving position-target 850. Each vehicle 108 may have dimensions, including a length and a width of the vehicle, as well as a minimum (or target) headway. In some embodiments, the headway may be specified or provided in units of time (e.g., 2 seconds), but correspond to a physical distance at a particular speed for a vehicle. As such the minimum headway may vary over different portions of the roadway. For example, the dimensions of vehicle 108-13 that is following the moving position-target 850 may include a length 852 and a headway 854. The headway 854 may be a minimum headway. In some situations, the minimum headway may be configured by the transportation system 110.

In one or more embodiments, the transportation system may allow each vehicle 108 a range of movement with reference to the moving position-target that the vehicle is following. For example, the vehicle 108-10 may have an allowed range of movement 824 as shown. Similarly, the vehicle 108-11 may have an allowed range of movement 834 as shown. In one or more embodiments, these ranges of movement may allow for flexibility within the transportation system to allow the passage of higher priority vehicles. For example, vehicle 420 having an exclusion area 422 may be proceeding along a priority path on one side of the roadway 800. A vehicle 108-12 may be following a moving position-target 840 on that same side of the roadway 800. The transportation system 110 may determine that the vehicle 108-12 interferes with the exclusion area 422 of the vehicle 420.

FIG. 8C depicts an example of a configuration 803 for the roadway 800 at a third time (t₂). At t₂, the transportation system (e.g., transportation system 110) has determined a revised moving position-target 842 for the vehicle 108-12, the revised moving position-target configured to remove the vehicle 108-12 from the exclusion area 422 (or prevent the vehicle 108-12 from interfering with the exclusion area 422). As a result of the revised moving position-target 842 for the adjacent vehicles, the vehicle 108-10 and the vehicle 108-11 may adjust their positions. For example, the vehicle 108-10 may shift back so that it has center 822 (which may be within the range of movement 824 for its moving position-target 820). Similarly, the vehicle 108-11 may shift forward so that it has center 832 (which may be within the range of movement 834 for its moving position-target 830). In some cases, the shifting of the vehicles 108-10 and 108-11 may result in the vehicles still maintaining a headway that is above a minimum headway, such that the other vehicles and/or moving position-targets in the sequence do not need to shift due to the merging of the vehicle 108-12. However, if the shifting of the vehicles would violate headway requirements or minimums of any vehicle and/or moving position-target, the transportation system 110 may adjust the moving position-targets and/or vehicles as appropriate to maintain target headways.

After the vehicle 420 and its associated exclusion area 422 pass, the vehicle 108-10 may return to following the moving position-target 820, the vehicle 108-11 may return to following the moving position-target 830, and the vehicle 108-12 may return to following the moving position-target 840. Stated another way, each vehicle may return to the nominal center of its range of movement (e.g., to the actual moving position target).

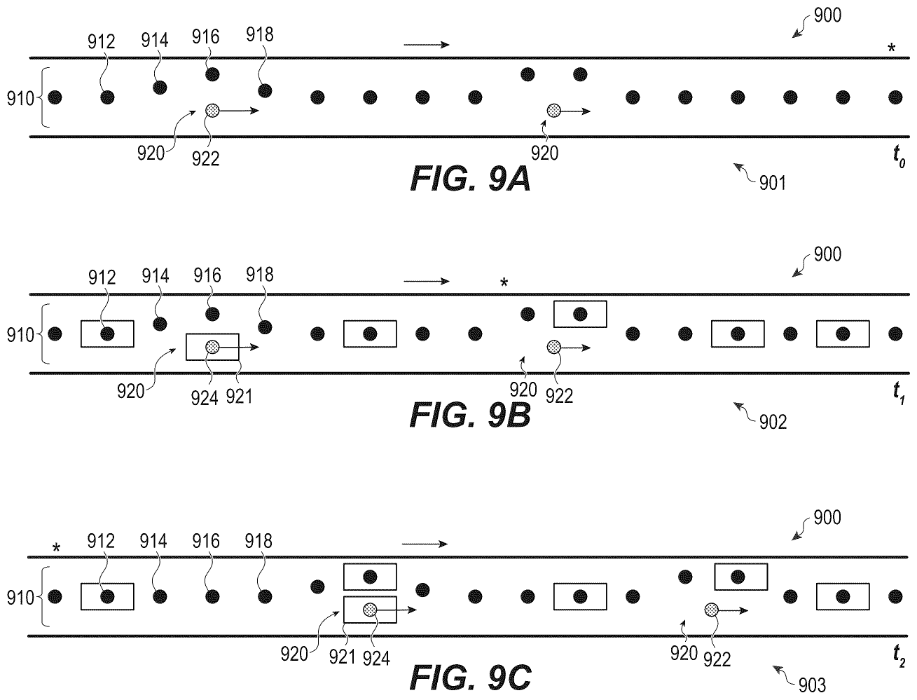

FIGS. 9A-9C generally depict an example of two sets of non-conflicting moving position-targets, where one set of moving position-targets may be configured to move faster (e.g., for priority vehicles) relative to a second set of moving position-targets, and the two sets of moving position-targets are configured to not overlap. In the example shown in FIGS. 9A-9C, the two sets of non-conflicting moving position-targets share the same roadway while moving to avoid interactions with each other. Stated another way, the moving position-targets are preconfigured with movements that allow faster moving position-targets to pass safely without having to recalculate or otherwise modify moving position-targets in real time.

FIG. 9A depicts an example of a configuration 901 of a section of roadway 900 of a transportation system, such as the transportation system 110 controlling the vehicles 108, that may be used to support scalable autonomous vehicle roadways in a transportation system. Roadway 900 may be an example of and include features of any of the roadways described herein, including roadway 200, roadway 400, roadway 500, roadway 600, roadway 700, or roadway 800.

At a first time (t₀), the configuration 901 includes both a first set of moving position-targets 910 (represented as black dots) and a second set of moving position-targets 920 (represented as stippled dots). In one or more embodiments, the moving position-targets 910 are moving position-targets utilized for autonomous vehicles having a relatively lower priority, and the moving position-targets 920 are moving position-targets utilized for autonomous vehicles having a relatively higher priority. In some embodiments, the second set of moving position-targets 920 may move relatively more quickly than the first set of moving position-targets 910. In other embodiments, the second set of moving position-targets 920 may move in an opposite direction than the first set of moving position-targets 910.

The moving position-targets 910 may be configured such that they are generally centered in the roadway 900, except in the case of a moving position-target associated with the second set of moving position-targets 920 “passing” the moving position-targets of the first set of moving position-targets 910. For example, moving position-target 912 may be generally centered in the roadway 900. The moving position-target 916 may be adjacent the moving position-target 922 (e.g., the moving position-target 922 is currently passing the moving position-target 916) and generally spaced in the roadway 900 to allow sufficient space (clearance, room) for two vehicles to be adjacent in the roadway, with one vehicle following the moving position-target 916 and another vehicle following the moving position-target 922. The moving position-target 914 and the moving position-target 918 may be generally transitioning between a position centered in the roadway 900 and a position nearest the edge of the roadway 900.

FIG. 9B depicts an example of a configuration 902 for the roadway 900 at a second time (t₁). At t₁, the configuration 902 includes a vehicle 921 following the moving position-target 924. The moving position-target 922 has moved forward relative to the set of moving position-targets 910 (e.g., the moving position-target 912, the moving position-target 914, the moving position-target 916, and the moving position-target 918).

FIG. 9C depicts an example of a configuration 903 for the roadway 900 at a third time (t₂). At t₂, the configuration 903 includes the vehicle 921 following the moving position-target 924. The moving position-target 924 has moved forward relative to the moving position-targets of the first set of moving position-targets 910 (e.g., the moving position-target 912, the moving position-target 914, the moving position-target 916, and the moving position-target 918).

FIGS. 9A-9C illustrate how multiple lanes of traffic at different speeds may be implemented using deconflicted moving position-targets, while maximizing or utilizing available space on a roadway. In particular, when no higher-speed moving position-targets are nearby, the slower moving position-targets may be positioned in the center of the roadway, providing each moving position-targets with a maximum available distance from the sides of the roadway (e.g., physical or logical sides). When a higher speed moving position-target passes, the moving position-targets of the lower speed sequence of moving position-targets temporarily shift to allow the faster moving position-target to pass, while maintaining a safe distance between all of the moving position-targets (and/or vehicles associated with the moving position-targets) and all roadway boundaries. Once the faster moving position-target has passed, the slower moving position-targets return to their mid-lane position. Of course, the positions of the slower moving position-targets need not be in the center of a roadway, nor do both sequences of moving position-targets need to be equidistant from each other and the roadway sides. Indeed, the technique described with respect to FIGS. 9A-9C may be implemented at any position in a roadway or roadway segment. Further, as described herein, FIGS. 9A-9C illustrate fully preconfigured deconflicted moving position-targets, such that the moving position-targets define these trajectories regardless of whether a vehicle is assigned to it. As such, when operating a roadway according to this configuration, the transportation system 110 may not need to revise moving position-targets when faster vehicles are approaching, since each moving position-target is fully deconflicted by design (e.g., the moving position-targets define safe trajectories that avoid unwanted vehicle interactions, maintain safe vehicle operations and separation distances, etc.). Accordingly, vehicles can be assigned to any of the moving position-targets without requiring modifications or revisions to the moving position-targets.

In each of FIGS. 4A-9C, the sets of moving position-targets, including vehicles following a moving position-target of the sets of moving position-targets, should be understood to generally move from left to right (e.g., in the direction of the indicated arrow) relative to the associated roadway that is depicted. This convention is for ease of illustration and is not necessarily limiting of potential implementations.

Moreover, the roadways depicted herein, and in particular roadways shown at different times, may not visually show the absolute motion of vehicles and/or moving position targets relative to the roadway. Rather, the figures will be understood as depicting relative positions between and among the illustrated vehicles and position targets as they move along the roadway. In some cases, it may be understood that the vehicles and/or position targets are advancing along the roadway, and the figures generally represent or depict a sliding window that tracks a set of vehicles and/or position targets as they move along the roadway (rather than depicting a stationary or fixed view of a portion of a roadway). Stated another way, while vehicles and/or moving position-targets may be depicted in the figures in the same position in a roadway at two different times, it will be understood that the vehicles and/or moving position-targets are in fact moving along the roadway. For case of illustration, an asterisk is included along the roadways in the figures to represent an example fixed position of the roadway and further illustrate the movement of vehicles and/or moving position-targets along the roadway.

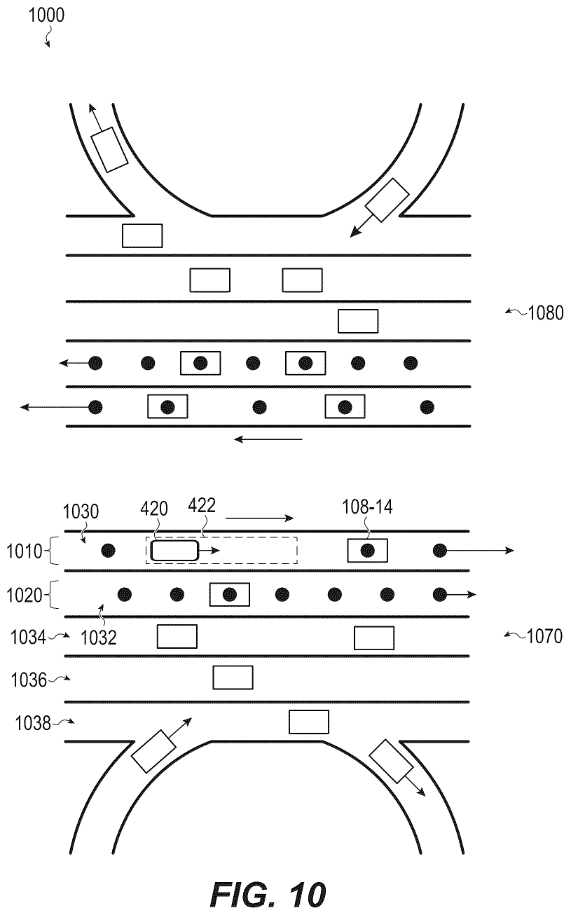

FIG. 10 depicts an example of a configuration of a section of a roadway system 1000 for a transportation system, such as the transportation system 110 controlling the vehicles 108, that may be used to support scalable autonomous vehicle roadways in a transportation system. Roadway system 1000 may be an example of and include features of any of the roadways described herein, including roadway 200, roadway 400, roadway 500, roadway 600, roadway 700, roadway 800, or roadway 900.

Roadway system 1000 includes aspects of a multi-lane, divided, controlled-access roadway with which one or more aspects of the scalable autonomous vehicle roadways described herein may be used. For example, for a first travel direction 1070, the roadway system 1000 may include five travel lanes. Because the travel lanes may be mixed in use, lane indicators may be provided. Two of the lanes, lane 1030 and lane 1032 may be controlled for autonomous vehicle use (e.g., vehicles 108, such as the vehicle 108-14) according to a first set of moving position-targets 1010 for lane 1030 and a second set of moving position-targets 1020 for lane 1032. According to techniques described herein, a higher-priority vehicle, the vehicle 420, having an exclusion area 422 may travel in the lane 1030. Three of the lanes, lane 1034, lane 1036, and lane 1038, may be open to non-autonomous vehicle use, such as the use of lanes 1034, 1036, and 1038 by non-autonomous vehicles. One of the lanes, for example lane 1038, may provide ingress and egress.

For a second travel direction 1080, a similar configuration may be provided, as for the first travel direction 1070. In some embodiments, the configuration may include a separation of the first travel direction 1070 and the second travel direction 1080 by a physical barrier, such as a grass divider, a concrete barrier, or other structure to provide a physical separation and/or distance.

One or more of the lanes having moving position-targets (e.g., lane 1030, lane 1032) may use any of the schemes or combination of schemes described herein (e.g., with reference to FIGS. 1A-9C) to allow a priority vehicle to pass. FIG. 10 generally illustrates how moving position-targets, and the various trajectory prioritization and dynamic lane concepts described herein may be implemented in a mixed-traffic roadway. Notably, the lanes in which moving position-target control is implemented may be dynamically selected, and need not be the same lanes. For example, moving position-target vehicle control may be implemented in all of the lanes, or other individual lanes. In some cases, lanes that are reserved for moving position-target control may be designated as such (e.g., with signs, markings, barriers, etc.). In some cases, vehicles may implement multiple different vehicle control and/or navigation schemes when operating in the roadway 1000. For example, vehicles may enter the roadway (e.g., in non-moving position-target lanes) under human control or under an autonomous control that does not follow moving position-targets (e.g., an autonomous control that does not follow a predefined spacetime trajectory). Such vehicles may be assigned to moving position-targets under certain circumstances or conditions (e.g., in response to the vehicle and/or an operator requesting access to the moving position-target lane), and may begin following the assigned moving position-target (e.g., by merging into the moving position-target controlled lane at the assigned moving position-target). When the vehicle needs to exit the roadway or otherwise end its traversal of the moving position-target lane, the vehicle may leave the moving position-target and resume human control (or autonomous control) outside of the moving position-target controlled lane.

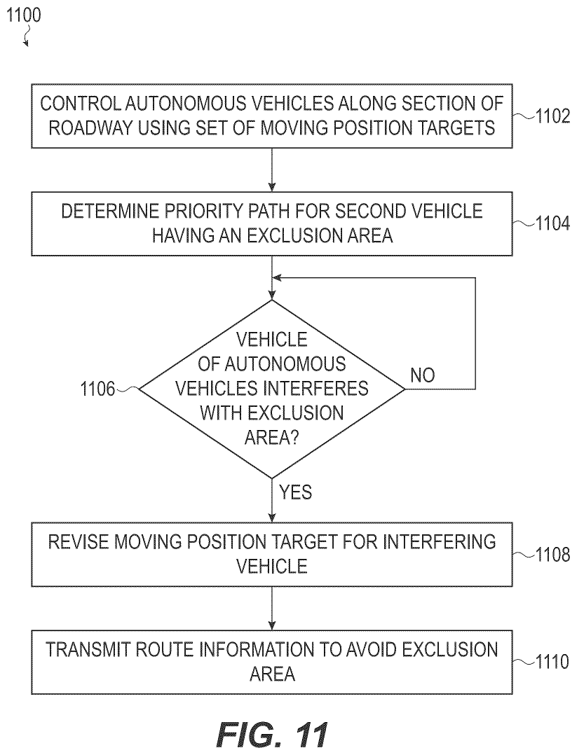

FIG. 11 shows an example method 1100 of navigating vehicles along a roadway, according to one or more aspects described herein. In one or more embodiments, method 1100 supports one or more aspects of software defined lanes for autonomous vehicle systems, as further described herein. In some cases, the vehicles may be examples of vehicle 108, or another autonomous vehicle described herein, including autonomous vehicles controlled by the transportation system 110. The method 1100 may be performed using the transportation system 110, including one or more components thereof. The method 1100 may use one or more schemes or combination of schemes described herein (e.g., with reference to FIGS. 1A-9C) to allow a priority vehicle to pass.

At 1102, the method 1100 includes controlling autonomous vehicles along roadways using a set of moving position-targets. In some embodiments, the method 1100 includes controlling a set of autonomous vehicles navigating along a section of a roadway by providing a set of moving position-targets for the set of autonomous vehicles, wherein the set of autonomous vehicles includes a first vehicle following a first moving position-target of the set of moving position-targets.

At 1104, the method 1100 includes determining a priority path for a vehicle having an exclusion area (e.g., a higher-priority vehicle). In some embodiments, the method 1100 includes determining a priority path along the section of the roadway for a second vehicle having a right-of-way priority along the section of the roadway, the second vehicle associated with an exclusion area ahead of the second vehicle along the priority path. In some embodiments, at 1104 the method 1100 includes determining that the first moving position-target interferes with a priority path for a second vehicle, in which case, the method 1100 proceeds to 1108.

At 1106, the method 1100 includes determining whether any autonomous vehicles interfere with the exclusion area. In some embodiments, the method 1100 includes determining, based at least in part on location information for the first vehicle, that the first vehicle interferes with the exclusion area associated with the second vehicle. If no, the method 1100 continues to monitor for exclusion area violations and/or interferences.

At 1108, the method 1100 includes, if yes, revising the moving position-target for any interfering vehicles. In some embodiments, the method 1100 includes determining a revised moving position-target for the first vehicle, the revised moving position-target configured to remove the first vehicle from the exclusion area (or otherwise prevent the vehicle from interfering with the exclusion area). In some embodiments, at 1108, the method 1100 includes determining a revised moving position-target for the first vehicle, the revised moving position-target configured to cause the first vehicle to avoid the priority path.

At 1110, the method 1100 includes causing the interfering vehicle to avoid the exclusion area. In some embodiments, the method 1100 includes transmitting, to the first vehicle, route information corresponding to the revised moving position-target, thereby causing the first vehicle to follow the revised moving position-target and avoid the exclusion area. In some embodiments, at 1110, the method 1100 includes transmitting, to the first vehicle, route information corresponding to the revised moving position-target, thereby causing the first vehicle to follow the revised moving position-target and avoid the priority path.

In one or more embodiments, the method further includes detecting that the exclusion area of the second vehicle has passed the first vehicle, and in response to detecting that the second vehicle has passed the first vehicle, transmitting, to the first vehicle, route information corresponding to the first moving position-target, thereby causing the first vehicle to return to the first moving position-target of the set of moving position-targets.

In some embodiments, the set of moving position-targets includes a first set of moving position-targets and a second set of moving position-targets, the first moving position-target is one of the first set of moving position-targets, the revised moving position-target is one of the second set of moving position-targets.

In some embodiments, the set of moving position-targets is a first set of moving position-targets, and the priority path is associated with a second moving position-target of a second set of moving position-targets associated with a right-of-way priority. In some embodiments, each moving position-target of the second set of moving position-targets traverses the section of the roadway at a greater speed than moving position-targets of the first set of moving position-targets.

In some embodiments, transmitting the route information corresponding to the revised moving position-target includes transmitting route information that causes the first vehicle to perform at least one of exiting the roadway or proceeding to a stationary position target (e.g., a parking spot or any other location at which the vehicle is assigned to remain stationary).

In one or more embodiments, the method further includes transmitting, to a third vehicle that is one of the set of autonomous vehicles and positioned at a stationary position target for the roadway, revised route information corresponding to the stationary position target. The method may further include maintaining a position of the third vehicle at the stationary position target until the exclusion area for the second vehicle has passed the stationary position target.

In some embodiments, the second vehicle is associated with a second priority level greater than a first priority level for the set of autonomous vehicles. In some embodiments, the second priority level of the second vehicle is associated with emergency response vehicles. In some embodiments, the second priority level of the second vehicle is associated with a mass transit vehicle.

In some embodiments, the second vehicle is a human operated vehicle.

The method 1100 may be variously embodied, extended, or adapted, as described in the following paragraphs and elsewhere in this description.

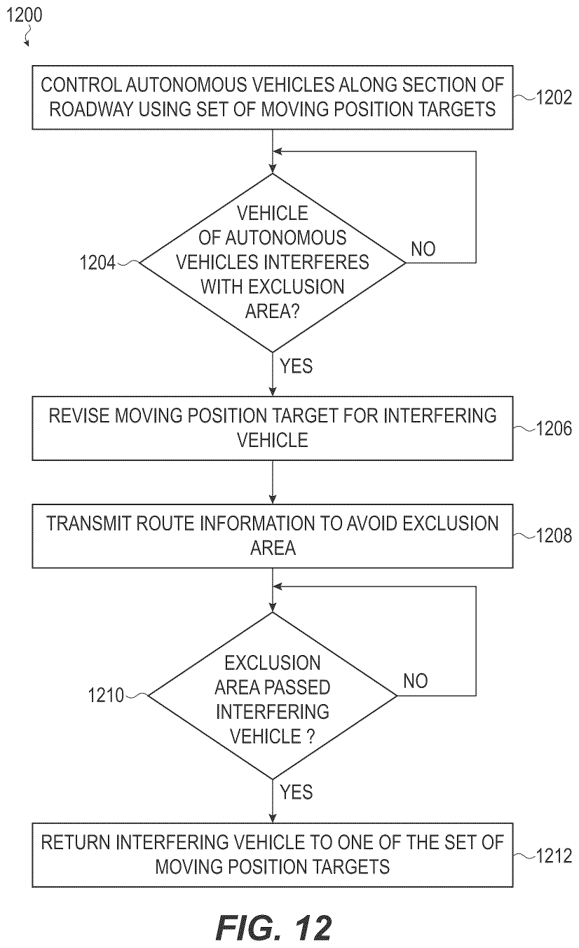

FIG. 12 shows an example method 1200 of navigating vehicles along a roadway, according to one or more aspects described herein. In one or more embodiments, method 1200 supports one or more aspects of software defined lanes for autonomous vehicle systems, as further described herein. In some cases, the vehicles may be examples of vehicle 108, or another autonomous vehicle described herein, including autonomous vehicles controlled by the transportation system 110. The method 1200 may be performed using the transportation system 110, including one or more components thereof.

At 1202, the method 1200 includes controlling autonomous vehicles along roadways using a set of moving position-targets. In some embodiments, the method 1200 includes controlling a set of autonomous vehicles navigating along a section of the roadway by providing a set of moving position-targets for the set of autonomous vehicles. In some embodiments, the set of autonomous vehicles includes a first vehicle following a first moving position-target of the set of moving position-targets.

At 1204, the method 1200 includes determining whether any autonomous vehicles interfere with an exclusion area. In some embodiments, the method 1200 includes determining, based at least in part on location information for the first vehicle, that the first vehicle interferes with an exclusion area associated with a second vehicle having right-of-way priority along a priority path of the section of the roadway. If no, the method 1200 continues to monitor for exclusion area violations and/or interferences.

At 1206, the method 1200 includes, if yes, revising the moving position-target for any interfering vehicles. In some embodiments, the method 1200 includes determining a revised moving position-target for the first vehicle, the revised moving position-target configured to remove the first vehicle from the exclusion area.

At 1208, the method 1200 includes causing the interfering vehicle to avoid the exclusion area. In some embodiments, the method 1200 includes transmitting, to the first vehicle, first route information corresponding to the revised moving position-target, thereby causing the first vehicle to follow the revised moving position-target and avoid the exclusion area.

At 1210, the method 1200 includes determining whether the autonomous vehicle has passed the exclusion area. In some embodiments, the method 1200 includes detecting that the exclusion area of the second vehicle has passed the first vehicle. In no, the method 1200 continues to monitor for exclusion area violations and/or interferences.

At 1212, the method 1200 includes, if yes, returning the vehicle to one of the set of moving position-targets. In some embodiments, the method 1200 includes transmitting, to the first vehicle, second route information corresponding to one of the set of moving position-targets, thereby causing the first vehicle to return to the first moving position-target or a second moving position-target of the set of moving position-targets.

In some embodiments, the set of moving position-targets includes a first set of moving position-targets and a second set of moving position-targets, the first moving position-target is one of the first set of moving position-targets, the revised moving position-target is one of the second set of moving position-targets.

In some embodiments, the set of moving position-targets is a first set of moving position-targets, and the priority path is associated with a moving position-target of a second set of moving position-targets, the second set of moving position-targets associated with the right-of-way priority, where each of at least a subset of the moving position-targets of the second set of moving position-targets traverses the section of the roadway at a greater speed than moving position-targets of the first set of moving position-targets.

In some embodiments, transmitting the route information corresponding to the revised moving position-target includes transmitting route information that causes the first vehicle to exit the roadway or proceed to a stationary position target.

The method 1200 may be variously embodied, extended, or adapted, as described in the following paragraphs and elsewhere in this description.

Embodiments contemplated herein include one or more non-transitory computer-readable media storing instructions to cause an electronic device, upon execution of the instructions by one or more processors of the electronic device, to perform one or more elements of the method 1100 or 1200. In the context of the method 1100 or the method 1200, this non-transitory computer-readable media may be, for example, a memory of a vehicle 108 and/or the transportation system 110.

Embodiments contemplated herein include an apparatus having logic, modules, or circuitry to perform one or more elements of the method 1100 or 1200. This apparatus may be, for example, an apparatus of a vehicle 108 and/or the transportation system 110, as described herein.

Embodiments contemplated herein include an apparatus having one or more processors and one or more computer-readable media, using or storing instructions that, when executed by the one or more processors, cause the one or more processors to perform one or more elements of the method 1100 or 1200. This apparatus may be, for example, an apparatus of a vehicle 108 and/or the transportation system 110, as described herein.

Embodiments contemplated herein include a signal as described in or related to one or more elements of the method 1100, or the method 1200.

Embodiments contemplated herein include a computer program or computer program product having instructions, wherein execution of the program by a processing system causes the processing system to carry out one or more elements of the method 1100 or 1200. In the context of method 1100 or method 1200, the processing may be performed by a processor of a vehicle 108 and/or the transportation system 110, as described herein, and the instructions may be, for example, located in the processor and/or on a memory of the vehicle 108 and/or the transportation system 110. In some cases, the processing system may be implemented by one or multiple computers or computing systems, including computers or computing systems that are physically separate and/or distributed at different locations and/or associated with different devices.

The transportation systems described herein may be configured for numerous vehicles to be autonomously operated to transport passengers and/or freight along roadway systems. For example, a transportation system or service may provide a fleet of vehicles that operate within the roadway system. Vehicles in such a transportation system may be configured to operate autonomously, such as according to one or more vehicle schemes as described herein (e.g., by following deconflicted trajectories assigned thereto to facilitate transport and boarding operations, among other possible vehicle operations/maneuvers). As used herein, the term “autonomous” may refer to a mode or scheme in which vehicles can operate without continuous, manual control by a human operator. For example, driverless vehicles may navigate along a roadway using a system of automatic drive and steering systems that control the speed and direction of the vehicle. In some cases, the vehicles may not require steering, speed, or directional control from the passengers, and may exclude controls such as passenger-accessible accelerator and brake pedals, steering wheels, and other manual controls. In some cases, the vehicles may include manual drive controls that may be used for maintenance, emergency overrides, or the like. Such controls may be hidden, stowed, or otherwise not directly accessible by a user during normal vehicle operation. For example, they may be designed to be accessed only by trained operators, maintenance personnel, or the like.

Autonomous operation need not exclude all human or manual operation of the vehicles or of the transportation system as a whole. For example, human operators may be able to intervene in the operation of a vehicle for safety, convenience, testing, or other purposes. Such intervention may be local to the vehicle, such as when a human driver takes control of the vehicle, or remote from the vehicle, such as when an operator sends commands to the vehicle via a remote-control system. Similarly, some aspects of the vehicles may be controlled by passengers of the vehicles. For example, a passenger in a vehicle may select a target destination, a path, a speed, control the operation of the doors and/or windows, or the like. Accordingly, it will be understood that the terms “autonomous” and “autonomous operation” do not necessarily exclude all human intervention or operation of the individual vehicles or of the overall transportation system.

The vehicles in the transportation system may include various sensors, cameras, communications systems, processors, and/or other components or systems that help facilitate autonomous operation. For example, the vehicles may include a sensor array that detects magnets or other markers embedded in the roadway and which help the vehicle determine its location, position, and/or orientation on the roadway. The vehicles may also include wireless vehicle-to-vehicle communications systems, such as optical communications systems, that allow the vehicles to inform one another of operational parameters such as their braking status, the number of vehicles ahead in a platoon, acceleration status, their next maneuver (e.g., right turn, left turn, planned stop), their number or type of payload (e.g., humans or freight), or the like. The vehicles may also include wireless communications systems to facilitate communication with a transportation control system that has supervisory command and control authority over the transportation system.

The vehicles in the transportation system may be designed to enhance the operation and convenience of the transportation system. For example, a primary purpose of the transportation system may be to provide comfortable, convenient, rapid, and efficient personal transportation. To provide personal comfort, the vehicles may be designed for easy passenger ingress and egress, and may have comfortable seating arrangements with generous legroom and headroom. The vehicles may also have a sophisticated suspension system that provides a comfortable ride and dynamically adjustable parameters to help keep the vehicle level, positioned at a convenient height, and to ensure a comfortable ride throughout a range of variable load weights.

Conventional personal automobiles are designed for operation primarily in only one direction. This is due in part to the fact that drivers are oriented forwards, and operating in reverse for long distances is generally not safe or necessary. However, in autonomous vehicles, where humans are not directly controlling the operation of the vehicle in real-time, it may be advantageous for a vehicle to be able to operate bidirectionally. For example, the vehicles in a transportation system as described herein may be substantially symmetrical, such that the vehicles lack a visually or mechanically distinct front or back. Further, the wheels may be controlled sufficiently independently so that the vehicle may operate substantially identically no matter which end of the vehicle is facing the direction of travel. This symmetrical design provides several advantages. For example, the vehicle may be able to maneuver in smaller spaces by potentially eliminating the need to make U-turns or other maneuvers to re-orient the vehicles so that they are facing “forward” before initiating a journey.

FIGS. 13A and 13B are perspective views of an example four-wheeled roadway vehicle 1300 (referred to herein simply as a “vehicle”) that may be used in a transportation system as described herein. FIGS. 13A-13B illustrate the symmetry and bidirectionality of the vehicle 1300. In particular, the vehicle 1300 defines a first end 1302, shown in the forefront in FIG. 13A, and a second end 1304, shown in the forefront in FIG. 13B. In some examples and as shown, the first end 1302 and the second end 1304 are substantially identical. Moreover, the vehicle 1300 may be configured so that it can be driven with either end facing the direction of travel. For example, when the vehicle 1300 is travelling in the direction indicated by arrow 1314, the first end 1302 is the leading end of the vehicle 1300, while when the vehicle 1300 is traveling in the direction indicated by arrow 1312, the second end 1304 is the leading end of the vehicle 1300.

The ability of the vehicles to operate bidirectionally may allow the roadway systems, and in particular boarding zones, to be made more compact. For example, when a vehicle that is configured to travel primarily only in one direction (e.g., with reverse operation being provided for convenience and maneuvering, but not for continuous driving functions) pulls into a blind parking spot, it must execute a y-turn maneuver in order to exit the parking spot and begin forward travel. On the other hand, a vehicle configured to operate equally well in either direction (e.g., a bidirectional vehicle) may simply exit the parking spot already facing the direction of travel. Accordingly, vehicles capable of bidirectional operation require less space to maneuver in boarding zones, allowing the boarding zones to be more compact and operate more efficiently. For example, a y-turn maneuver could temporarily block more adjacent parking spots than a vehicle that can simply turn directly towards its desired direction of travel, regardless of which direction that is. And while pull-through parking spots may eliminate the need to perform y-turn maneuvers in unidirectional vehicles, boarding zones with pull-through parking spots require a larger area than those with blind parking spots. Accordingly, using bidirectional vehicles, such as the vehicle 1300, facilitates the use of smaller, more compact boarding zones and more efficient operation of the boarding zones.

The vehicle 1300 may also include wheels 1306 (e.g., wheels 1306-1, 1306-4). The wheels 1306 may be paired according to their proximity to an end of the vehicle. Thus, wheels 1306-1, 1306-3 may be positioned proximate the first end 1302 of the vehicle and may be referred to as a first pair of wheels 1306, and the wheels 1306-2, 1306-4 may be positioned proximate the second end 1304 of the vehicle and may be referred to as a second pair of wheels 1306. Each pair of wheels may be driven by at least one motor (e.g., an electric motor), and each pair of wheels may be able to steer the vehicle. Because each pair of wheels is capable of turning to steer the vehicle, the vehicle may have similar driving and handling characteristics regardless of the direction of travel. In some cases, the vehicle may be operated in a two-wheel steering mode, in which only one pair of wheels steers the vehicle 1300 at a given time. In such cases, the particular pair of wheels that steers the vehicle 1300 may change when the direction of travel changes. In other cases, the vehicle may be operated in a four-wheel steering mode, in which the wheels are operated in concert to steer the vehicle. In a four-wheel steering mode, the pairs of wheels may either turn in the same direction or in opposite directions, depending on the steering maneuver being performed and/or the speed of the vehicle.

The vehicle 1300 may also include doors 1308, 1310 that open to allow passengers and other payloads (e.g., packages, luggage, freight) to be placed inside the vehicle 1300. The doors 1308, 1310, which are described in greater detail herein, may extend over the top of the vehicle such that they each define two opposite side segments. For example, each door defines a side segment on a first side of the vehicle and another side segment on a second, opposite side of the vehicle. The doors also each define a roof segment that extends between the side segments and defines part of the roof (or top side) of the vehicle. In some cases, the doors 1308, 1310 resemble an upside-down “U” in cross-section and may be referred to as canopy doors. The side segments and the roof segment of the doors may be formed as a rigid structural unit, such that all of the components of the door (e.g., the side segments and the roof segment) move in concert with one another. In some cases, the doors 1308, 1310 include a unitary shell or door chassis that is formed from a monolithic structure. The unitary shell or door chassis may be formed from a composite sheet or structure including, for example, fiberglass, carbon composite, and/or other lightweight composite materials.

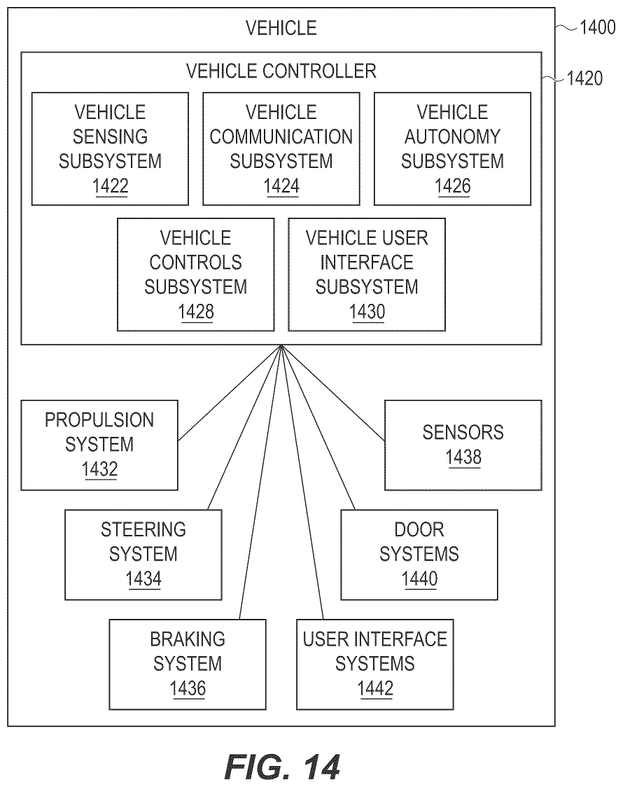

The vehicle 1300 may also include a vehicle controller 1420 (FIG. 14) that controls the operations of the vehicle 1300 and the vehicle's systems and/or subsystems. For example, the vehicle controller may control the vehicle's drive system, steering system, suspension system, doors, and the like, to facilitate vehicle operation, including navigating the vehicle along a roadway in accordance with one or more vehicle control schemes. The vehicle controller may also be configured to communicate with other vehicles, the transportation control system (e.g., the CMS 102, monitoring systems 106, the dispatch system 104, etc.), vehicle presence detectors, or other components of the transportation system. For example, the vehicle controller may be configured to receive information from other vehicles about those vehicles' position in a platoon, speed, upcoming speed or direction changes, or the like. The vehicle controller may also be configured to receive information from vehicle presence detectors about available vehicle positions. The vehicle controller may include computers, processors, memory, circuitry, or any other suitable hardware components, and may be interconnected with other systems of the vehicle to facilitate the operations described herein, as well as other vehicle operations.

FIG. 14 is a schematic representation of the vehicle 1400, illustrating an example set of systems that may facilitate and/or implement the operations and techniques described herein. Vehicle 1400 may be an example of a vehicle 1300. The vehicle 1400 may include a vehicle controller 1420. The vehicle controller 1420 may include a vehicle sensing subsystem 1422, a vehicle communications subsystem 1424, a vehicle autonomy subsystem 1426, a vehicle controls subsystem 1428, and a vehicle user interface (UI) subsystem 1430. The vehicle controller 1420 may be coupled to various physical and/or hardware components of the vehicle 1400, including but not limited to propulsion system(s) 1432, steering system(s) 1434, braking system(s) 1436, sensor(s) and/or sensing system(s) 1438, door system(s) 1440, user interface system(s) 1442, and the like.

The vehicle sensing subsystem 1422 may include or be coupled to sensing systems 1438, which may include tri-band redundant sensing (lidar, radar, camera), providing high-resolution (e.g., about 0.2 to about 2.0 mrad), low-latency (e.g., less than about 100 ms latency), and long-range sensor data (e.g., greater than about 600 ft). The vehicle sensing subsystem 1422 may provide and/or access sensor data that is used to determine vehicle state (e.g., position, velocity, acceleration) as well as to provide detection and localization of other objects in the system including other vehicles and any intrusions into the system.

The vehicle communications subsystem 1424 may include dual-band redundant wireless communications. This subsystem may provide trajectory information (e.g., fully deconflicted vehicle trajectories) and movement authority signals to the vehicle (where the movement authority signal is a continuous signal required for any permissive state on the system). The vehicle communications subsystem 1424 may also transmit vehicle state information to other system components (e.g., other vehicles, the CMS 102, monitoring systems 106, the dispatch system 104, etc.). The vehicle communications subsystem 1424 may also transmit and/or receive redundant/diverse system observations (e.g., intrusion observations, vehicle observations) across the system.

The vehicle autonomy subsystem 1426 may facilitate the autonomous operation of the vehicle 1400 including assuring the safety of the vehicle 1400 in varied conditions including any and all failures of off-vehicle components (e.g., the CMS 102, monitoring systems 106, the dispatch system 104, etc.). The vehicle autonomy subsystem 1426 may use the output of the vehicle sensing subsystem 1422 as input and, based at least in part on the output, provide vehicle ego-localization (e.g., the location of the vehicle 1400 in space and/or with respect to the transportation system) and object detection/localization (including other vehicles and foreign objects on or adjacent to the roadway). The vehicle autonomy subsystem 1426 may cross-check its ego-localization and object reports against diverse and redundant sources (e.g., reports from roadside monitoring systems and other vehicles) and may enforce safety invariants with respect to these results (e.g., maintaining safe separation distances, etc.). The vehicle may periodically (e.g., at a frequency of about 10 cycles per second) or otherwise provide both a current safe motion plan and a fail-safe motion plan to the vehicle controls subsystem 1428 (to be executed in the event a motion plan is not received on subsequent cycles).

The vehicle controls subsystem 1428 may control vehicle actuators (e.g., propulsion, braking, steering, doors, etc.) and may maintain the vehicle in a safe state. The vehicle controls subsystem 1428 may include safety-critical software running on safety-critical processing hardware (e.g., checked-redundancy via dual lockstep processors). The vehicle steering and braking systems may support a fail-safe design with respect to a loss of signal from the vehicle controls subsystem 1428 via hardware watchdog timers.

The vehicle UI subsystem 1430 may facilitate user interactions within the vehicle including, without limitation, verifying passenger identity (via NFC scan), allowing the user to initiate the trip, and providing information to the user over the course of the trip (e.g., time to arrival, alert prior to arrival). The vehicle UI subsystem 1430 may include displays, touchscreen displays, output systems (e.g., lights, speakers) user input systems (e.g., keyboard, buttons, microphones), as well as other possible user interface components or systems.

The vehicle UI subsystem 1430 may provide various outputs and accept various inputs from passengers during a trip. For example, during a trip, the vehicle UI subsystem 1430 may communicate ride progress, display messages, and provide access to customer support.

In one example, once a rider enters the vehicle, the vehicle UI subsystem 1430 may provide an audio and/or visual output prompting the passenger to identify themselves (e.g., to present a credential item, ticket, etc.). The vehicle UI subsystem 1430 may also include an NFC antenna, optical scanner, or other system to allow the user to identify themselves or otherwise provide credentials to the system. After the passenger identifies themself, the vehicle UI subsystem 1430 may provide audio and/or visual outputs indicating that doors will close (and optionally providing a countdown, such as a 3 second countdown). At any point, the passenger can interact with the vehicle UI subsystem 1430 to stop the doors from closing. Once the doors are closed, the vehicle UI subsystem 1430 may provide an audio and/or visual output indicating that departure is imminent.

During the ride, a progress bar or other trip progress information (e.g., a moving indication on a map of the roadway system) may be displayed to the user, via the vehicle's user interface and/or on the user's device. During the ride, the user may access customer support via the vehicle or their mobile phone or other device. Prior to arrival at a destination, the vehicle UI subsystem 1430 may produce an audio and/or visual output indicating that they are about to arrive at their destination. A countdown may optionally be provided as well.

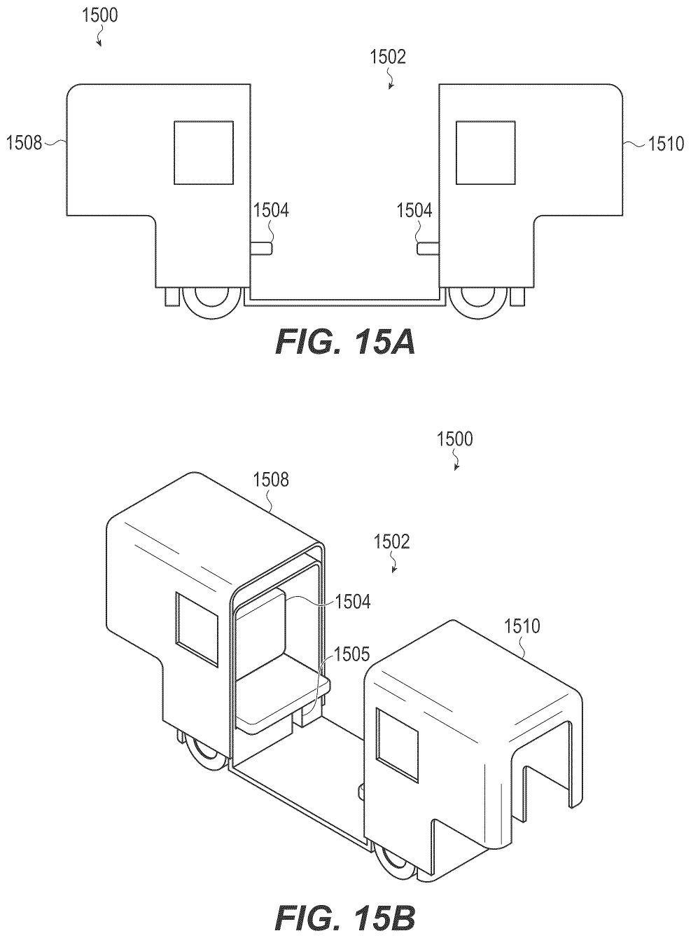

FIGS. 15A and 15B are side and perspective views, respectively, of a vehicle 1500 with the doors 1508, 1510 in an open state. Vehicle 1500 may be an example of a vehicle 1300 and/or a vehicle 1400. Because the doors 1508, 1510 each define two opposite side segments and a roof segment, an uninterrupted internal space 1502 may be revealed when the doors 1508, 1510 are opened. In the example depicted in FIGS. 15A and 15B, when the doors 1508, 1510 are opened, an open section may be defined between the doors 1508, 1510 that extends from one side of the vehicle 1500 to the other. This may allow for unimpeded ingress and egress into the vehicle 1500 by passengers on either side of the vehicle 1500. The lack of an overhead structure when the doors 1508, 1510 are opened may allow passengers to walk across the vehicle 1500 without a limit on the overhead clearance.

The vehicle 1500 may also include seats 1504, which may be positioned at opposite ends of the vehicle 1500 and may be facing one another. As shown, the vehicle includes two seats 1504, though other numbers of seats and other arrangements of seats are also possible (e.g., zero seats, one seat, three seats, etc.). In some cases, the seats 1504 may be removed, collapsed, or stowed so that wheelchairs, strollers, bicycles, or luggage may be more easily placed in the vehicle 1500. For example, the seats may be hinged or otherwise articulatable such that the seat surface can be raised to provide more room in the vehicle for other objects. In some cases, the vehicle 1500 may include a bicycle retention system positioned below the seat surface, such that upon raising the seat surface, a bicycle wheel may be secured to the bicycle retention system. The bicycle retention system may include a slot 1505 into which a bicycle wheel may be at least partially inserted in order to maintain the bicycle in an upright configuration. The slot 1505 may be offset from a center line of the vehicle to provide adequate space for passengers and other payload.

FIG. 16 illustrates a sample electrical block diagram of an electronic device 1600 that may perform the operations described herein. The electronic device 1600 may in some cases take the form of any of the electronic devices described herein, including the CMS 102, the monitoring systems 106, the dispatch system 104 (including trunk routers and node routers such as boarding zone routers, intersection routers, transition zone routers, etc.), vehicle controller 1420, vehicle user interfaces, boarding zone kiosks, portable electronic devices, or other computing devices or systems that are described herein or that are usable in order to perform the operations or instantiate the systems and/or services described herein. The electronic device 1600 can include one or more of a display 1612, a processing unit 1602, a power source 1614, a memory 1604 or storage device, input device(s) 1606, and output device(s) 1610. In some cases, various implementations of the electronic device 1600 may lack some or all of these components and/or include additional or alternative components.

The processing unit 1602 can control some or all of the operations of the electronic device 1600. The processing unit 1602 can communicate, either directly or indirectly, with some or all of the components of the electronic device 1600. For example, a system bus 1616 or other communication mechanism can provide communication between the processing unit 1602, the power source 1614, the memory 1604, the input device(s) 1606, and the output device(s) 1610.

The processing unit 1602 can be implemented as any electronic device capable of processing, receiving, or transmitting data or instructions. For example, the processing unit 1602 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1600 can be controlled by multiple processing units. For example, select components of the electronic device 1600 (e.g., an input device 1606) may be controlled by a first processing unit and other components of the electronic device 1600 (e.g., the display 1612) may be controlled by a second processing unit, where the first and second processing units may or may not be in communication with each other.

The power source 1614 can be implemented with any device capable of providing energy to the electronic device 1600. For example, the power source 1614 may be one or more batteries or rechargeable batteries. Additionally, or alternatively, the power source 1614 can be a power connector or power cord that connects the electronic device 1600 to another power source, such as a wall outlet.

The memory 1604 can store electronic data that can be used by the electronic device 1600. For example, the memory 1604 can store electronic data or content such as, for example, trip requests, user information, historical usage data, maps and/or layouts of the transportation system, vehicle data (e.g., information about each vehicle in the system, including assignment status, remaining charge, maintenance history, etc.), or the like. The memory 1604 can be configured as any type of memory. By way of example only, the memory 1604 can be implemented as random access memory, read-only memory, Flash memory, removable memory, other types of storage elements, or combinations of such devices.

In various embodiments, the display 1612 provides a graphical output, for example, associated with an operating system, user interface, and/or applications of the electronic device 1600. In one embodiment, the display 1612 includes one or more sensors and is configured as a touch-sensitive (e.g., single-touch, multi-touch) and/or force-sensitive display to receive inputs from a user. For example, the display 1612 may be integrated with a touch sensor (e.g., a capacitive touch sensor) and/or a force sensor to provide a touch- and/or force-sensitive display. The display 1612 is operably coupled to the processing unit 1602 of the electronic device 1600.

The display 1612 can be implemented with any suitable technology, including, but not limited to liquid crystal display (LCD) technology, light emitting diode (LED) technology, organic light-emitting display (OLED) technology, organic electroluminescence (OEL) technology, or another type of display technology. In some cases, the display 1612 is positioned beneath and viewable through a cover that forms at least a portion of an enclosure of the electronic device 1600.

In various embodiments, the input device(s) 1606 may include any suitable components for detecting inputs. Examples of input device(s) 1606 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1606 may be configured to detect one or more particular types of input and provide a signal (e.g., an input signal) corresponding to the detected input. The signal may be provided, for example, to the processing unit 1602.

The output device(s) 1610 may include any suitable components for providing outputs. Examples of output device(s) 1610 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 1610 may be configured to receive one or more signals (e.g., an output signal provided by the processing unit 1602) and provide an output corresponding to the signal(s).

In some cases, input device(s) 1606 and output device(s) 1610 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1602 may be operably coupled to the input device(s) 1606 and the output device(s) 1610. The processing unit 1602 may be adapted to exchange signals with the input device(s) 1606 and the output device(s) 1610. For example, the processing unit 1602 may receive an input signal from an input device 1606 that corresponds to an input detected by the input device 1606. The processing unit 1602 may interpret the received input signal to determine whether to provide and/or change one or more outputs in response to the input signal. The processing unit 1602 may then send an output signal to one or more of the output device(s) 1610, to provide and/or change outputs as appropriate.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. For example, while the methods or processes disclosed herein have been described and shown with reference to particular operations performed in a particular order, these operations may be combined, sub-divided, or re-ordered to form equivalent methods or processes without departing from the teachings of the present disclosure. Moreover, structures, features, components, materials, steps, processes, or the like, that are described herein with respect to one embodiment may be omitted from that embodiment or incorporated into other embodiments. Further, while the term “roadway” is used herein to refer to structures that support moving vehicles, the roadways described herein do not necessarily conform to any definition, standard, or requirement that may be associated with the term “roadway,” such as may be used in laws, regulations, transportation codes, or the like. As such, the roadways described herein are not necessarily required to (and indeed may not) provide the same features and/or structures of a “roadway” as defined or used in other contexts. Of course, the roadways described herein may comply with any and all applicable laws, safety regulations, or other rules for the safety of passengers, bystanders, operators, builders, maintenance personnel, or the like.

What is claimed is:

1. A method of navigating vehicles along a roadway, comprising:
controlling a set of autonomous vehicles navigating along a section of the roadway by providing a set of moving position-targets for the set of autonomous vehicles, wherein the set of autonomous vehicles includes a first vehicle following a first moving position-target of the set of moving position-targets;
determining that the first moving position-target interferes with a priority path for a second vehicle;
determining a revised moving position-target for the first vehicle, the revised moving position-target configured to cause the first vehicle to avoid the priority path; and
transmitting, to the first vehicle, route information corresponding to the revised moving position-target, thereby causing the first vehicle to follow the revised moving position-target and avoid the priority path.

2. The method of claim 1, further comprising:
detecting that the second vehicle has passed the first vehicle; and
in response to detecting that the second vehicle has passed the first vehicle, transmitting, to the first vehicle, route information corresponding to the first moving position-target, thereby causing the first vehicle to return to the first moving position-target of the set of moving position-targets.

3. The method of claim 1, wherein:
the set of moving position-targets comprises a first set of moving position-targets and a second set of moving position-targets;
the first moving position-target is one of the first set of moving position-targets; and
the revised moving position-target is one of the second set of moving position-targets.

4. The method of claim 1, wherein:
the set of moving position-targets is a first set of moving position-targets; and
the priority path is associated with a second moving position-target of a second set of moving position-targets associated with a right-of-way priority, wherein each of at least a subset of moving position-targets of the second set of moving position-targets traverses the section of the roadway at a greater speed than moving position-targets of the first set of moving position-targets.

5. The method of claim 1, wherein transmitting the route information corresponding to the revised moving position-target comprises transmitting route information that causes the first vehicle to perform at least one of exiting the roadway or proceeding to a stationary position target.

6. The method of claim 1, wherein determining that the first moving position-target interferes with the priority path for the second vehicle comprises determining that the first moving position-target overlaps an exclusion area associated with the second vehicle.

7. The method of claim 1, wherein the second vehicle is associated with a second priority level greater than a first priority level for the set of autonomous vehicles.

8. The method of claim 7, wherein the second priority level of the second vehicle is associated with emergency response vehicles.

9. The method of claim 7, wherein the second priority level of the second vehicle is associated with a mass-transit vehicle.

10. The method of claim 7, wherein the second vehicle is a human operated vehicle.

11. A method of navigating vehicles along a roadway, comprising:
controlling a set of autonomous vehicles navigating along a section of the roadway by providing a set of moving position-targets for the set of autonomous vehicles, wherein the set of autonomous vehicles includes a first vehicle following a first moving position-target of the set of moving position-targets;
determining, based at least in part on location information for the first vehicle, that the first vehicle interferes with an exclusion area associated with a second vehicle having right-of-way priority along a priority path of the section of the roadway;
in response to determining that the first vehicle interferes with the exclusion area, determining a revised moving position-target for the first vehicle, the revised moving position-target configured to remove the first vehicle from the exclusion area;
transmitting, to the first vehicle, first route information corresponding to the revised moving position-target, thereby causing the first vehicle to follow the revised moving position-target and avoid the exclusion area;
detecting that the exclusion area of the second vehicle has passed the first vehicle; and
transmitting, to the first vehicle, second route information corresponding to one of the set of moving position-targets, thereby causing the first vehicle to return to the first moving position-target or a second moving position-target of the set of moving position-targets.

12. The method of claim 11, wherein:
the set of moving position-targets comprises a first set of moving position-targets and a second set of moving position-targets;
the first moving position-target is one of the first set of moving position-targets; and
the revised moving position-target is one of the second set of moving position-targets.

13. The method of claim 11, wherein:
the set of moving position-targets is a first set of moving position-targets; and
the priority path is associated with a moving position-target of a second set of moving position-targets, the second set of moving position-targets associated with the right-of-way priority, wherein each of at least a subset of moving position-targets of the second set of moving position-targets traverses the section of the roadway at a greater speed than moving position-targets of the first set of moving position-targets.

14. The method of claim 11, wherein transmitting the first route information corresponding to the revised moving position-target comprises transmitting route information that causes the first vehicle to perform at least one of exiting the roadway or proceeding to a stationary position target.

15. A transportation system comprising:
a set of autonomous vehicles that includes a first vehicle; and
a vehicle controller configured to:
control the set of autonomous vehicles navigating along a section of a roadway by providing a set of moving position-targets for the set of autonomous vehicles, wherein the first vehicle follows a first moving position-target of the set of moving position-targets;
determine a priority path along the section of the roadway for a second vehicle having a right-of-way priority along the section of the roadway, the second vehicle associated with an exclusion area extending ahead of the second vehicle along the priority path;
determine, based at least in part on location information for the first vehicle, that the first vehicle interferes with the exclusion area associated with the second vehicle;
determine a revised moving position-target for the first vehicle, the revised moving position-target configured to remove the first vehicle from the exclusion area; and
transmit, to the first vehicle, route information corresponding to the revised moving position-target, thereby causing the first vehicle to follow the revised moving position-target and avoid the exclusion area.

16. The transportation system of claim 15, wherein the vehicle controller is further configured to:
detect that the exclusion area of the second vehicle has passed the first vehicle; and
in response to detecting that the exclusion area of the second vehicle has passed the first vehicle transmit, to the first vehicle, route information corresponding to the first moving position-target, thereby causing the first vehicle to return to the first moving position-target of the set of moving position-targets.

17. The transportation system of claim 15, wherein:
the set of moving position-targets comprises a first set of moving position-targets and a second set of moving position-targets;
the first moving position-target is one of the first set of moving position-targets; and
the revised moving position-target is one of the second set of moving position-targets.

18. The transportation system of claim 15, wherein:
the set of moving position-targets is a first set of moving position-targets; and
the priority path is associated with a second moving position-target of a second set of moving position-targets, the second set of moving position-targets associated with the right-of-way priority, wherein each of at least a subset of moving position-targets of the second set of moving position-targets traverses the section of the roadway at a greater speed than moving position-targets of the first set of moving position-targets.

19. The transportation system of claim 15, wherein transmitting the route information corresponding to the revised moving position-target comprises transmitting route information that causes the first vehicle to perform at least one of exiting the roadway or proceeding to a stationary position target.

20. The transportation system of claim 15, wherein the exclusion area extends a first distance ahead of the second vehicle in the direction of travel and a second distance behind the second vehicle.
